(19) United States
(12) Patent Application Publication
(10) Pub. No.: US 2023/0401604 A1
(43) Pub. Date: Dec. 14, 2023

(54) SYSTEMS AND METHODS FOR COMPOSING A MEDIA FEED FOR A TARGET USER BY SELECTING MEDIA ASSETS THAT SHARE CONGRUENT OBJECTS WITH A SECONDARY CONTENT ITEM

(71) Applicant: Rovi Guides, Inc., San Jose, CA (US)

(72) Inventors: Mona Singh, Cary, NC (US); Reda Harb, Bellevue, WA (US)

(21) Appl. No.: 17/836,391

(22) Filed: Jun. 9, 2022

(51) Int. Cl. G06Q 30/02; G06F 16/9536; G06Q 50/00; G06F 16/9538

(52) U.S. Cl. CPC G06Q 30/0255; G06F 16/9536; G06Q 50/01; G06F 16/9538

(57) ABSTRACT

Systems and methods for determining shared congruent objects between warming up media assets and a secondary content item are described. The warming up media assets, along with their reactions, are posted on a social media platform. A secondary content item is identified for display and congruent objects displayed in the secondary content item are used as recommendations to identify the warming up media assets. In some embodiments, the warming media assets do not include a display of the product or service that is the focus of the secondary content item. The congruent objects used as recommendations are determined based on selection of a reinforcement strategy which ranges from a soft to a hard reinforcement. Once a warming up media asset is identified, instructions are transmitted for its display, which may include displaying it at the top of a social media feed and auto-playing the warming up media asset.

### FIELD OF INVENTION

Embodiments of the present disclosure relate to comparing congruent objects in media assets posted on a social media platform based on recommendations provided by an advertisement server for priming or warming up a user prior to their consumption of a secondary content item, scoring the posted media assets based on their relevance to the recommendations, and determining their display format and order on the social media platform.

### BACKGROUND

A variety of video and ad recommendation techniques are commonly used to present content to the users. For example, if a user has consumed a certain type of content, such as a video, on a social media platform, such as Facebook™, Instagram™, TikTok™, YouTube™, more of the same type of videos are recommended to the user. The systems determine that the video consumed is of interest to the user, and more of the same type and genre of videos are displayed in their feed. For example, if a user has consumed a video about NBA basketball, more NBA basketball videos are recommended.

Social media platforms also allow users to post and share user-generated posts, images, videos, memes, and other content. It is common for social media platforms to select a subset of videos to recommend to a user on their “For You” page. The selected videos are usually videos shared by other users that are socially linked to the user e.g., the relationship (edge between nodes in graph) is of Type: Friend or Type: Friend of a Friend, etc. Algorithms running the background of these social platforms analyze the user's watch history and based on implicit or explicit user feedback, recommend the videos to be displayed.

Other techniques, such as those used by video recommendation systems, especially systems that recommend UGC (user-generated content), rely on tags to identify related videos (in addition to other metadata). These techniques may match a tag associated with consumed content with a tag of another video or ad and recommend the video or ad based on the matching of tags, such as sports, comedy, or specific names like Toyota™, or Tom Cruise, etc.

More sophisticated video recommendation systems rely on artificial intelligence (AI) to analyze movies consumed or “liked” by a user and find movies that are related to the movies consumed or selected. For example, the AI systems may find movies that are super-hero movies with themes that are consistent with themes of superhero movies that the user consumed or linked in the past. These systems may also analyze content, such as a movie consumed, on a frame-by-frame basis and tag and label objects within such frames such that the tags and labels can be used to extract features of the frame and used for recommendations.

In other settings, such as online shopping, or referral marketing, systems determine user interactions with products and services. For example, these systems determine if a user browsed certain products and services on an online shopping platform, which products they bought, and which products they left abandoned in shopping carts. Such data is used to send reminders to the user to buy the abandoned products or to send an ad for the product browsed, bought, or left abandoned.

One problem with such recommendation systems is that many users feel that they are very intrusive. For example, seeing an ad for the exact same product browsed earlier may turn off some consumers and be viewed as highly intrusive monitoring of their online activity. Additionally, some users may not react well to such hard-sell tactics where they constantly see ads for a product they once browsed, leading to them turn away from the product altogether.

Another problem with the current techniques is that they do not provide a personal touch to the recommendations. For example, the recommendations are typically the ad produced directly from the product manufacturer or the movie from the movie production or media marketing company that touts its advantages. Users may feel such biased propaganda is self-serving and lacking a personal touch.

As such, methods and systems are needed that warmup or prime the user prior to their consumption of an ad and provide a personal touch, as such through the user's contacts, to enhance their ad consumption experience and provide for a better reinforcement of the product being displayed in the ad.

### BRIEF DESCRIPTION OF THE FIGURES

The various objects and advantages of the disclosure will be apparent upon consideration of the following detailed description, taken in conjunction with the accompanying drawings, in which like reference characters refer to like parts throughout, and in which:

FIG. 1 is a block diagram of an example of a process for identifying media assets posted on a platform and determining their order of display in a social media feed based on shared congruent objects between the media asset and a secondary content item, in accordance with some embodiments of the disclosure;

FIG. 2 is a block diagram of another example of a process for identifying media assets posted on a platform and determining their order of display in a social media feed based on shared congruent objects between the media asset and a secondary content item, in accordance with some embodiments of the disclosure;

FIG. 3 is a block diagram of an exemplary system for identifying media assets posted on a platform and determining their order of display in a social media feed based on the media assets' shared congruent objects with a secondary content item, in accordance with some embodiments of the disclosure;

FIG. 4 is a block diagram of communications between different components of the system to identify media assets posted on a platform and determine their order of display in a social media feed based on the media assets' shared congruent objects with a secondary content item, in accordance with some embodiments of the disclosure;

FIG. 5 is a block diagram of a system, in accordance with some embodiments of the disclosure;

FIG. 6 is a block diagram of a media/display device, in accordance with some embodiments of the disclosure;

FIGS. 7A-7B are flowcharts of a process for identifying media assets posted on a platform and determining their order of display in a social media feed based on the media assets' shared congruent objects with a secondary content item, in accordance with some embodiments of the disclosure;

FIG. 8 is flowchart of a process for determining the display order for media assets in a social media feed, in accordance with some embodiments of the disclosure;

FIG. 9 is a block diagram of input categories used in identifying a related ad, in accordance with some embodiments of the disclosure;

FIG. 10 is a block diagram of display options for displaying an identified media asset in a social media feed, in accordance with some embodiments of the disclosure;

FIGS. 11A-C are block diagrams and tables of examples of a sliding scale that ranges from soft to hard reinforcements used in identifying media assets on a social media platform, in accordance with some embodiments of the disclosure;

FIG. 12 is a block diagram of examples of media assets identified for display on a social media platform, in accordance with some embodiments of the disclosure;

FIG. 13 is a data structure for identifying media assets posted on a platform and determining their order of display in a social media feed based on the media assets' shared congruent objects with a secondary content item, in accordance with some embodiments of the disclosure; and

FIG. 14 depicts a scoring engine and process applied for scoring media assets posted on a social media platform for determining their display order, in accordance with some embodiments of the disclosure.

### DETAILED DESCRIPTION

In accordance with some embodiments disclosed herein, some of the above-mentioned limitations are overcome by comparing congruent objects in media assets posted on a social media platform to recommendations provided by an advertisement server, scoring the posted media assets based on their relevance to the recommendations, and determining their display on the social media platform, such as in a social media feed or a “For You” page, based on the recommendation, which may range from soft to hard, or low to high priming and warming up. The above-mentioned limitations are also overcome by identifying relevant media assets posted on a social platform and using them to warmup, prime, or engage a user prior to their consumption of an identified secondary content item.

As referred to herein, the terms “media asset,” “content,” and “video” may be understood to mean electronically consumable user assets, such as television programming, as well as pay-per-view programs, on-demand programs (as in video-on-demand (VOD) systems), Internet content (e.g., streaming content, downloadable content, Webcasts, etc.), video clips, audio, content information, pictures, GIFs, rotating images, documents, playlists, websites, articles, books, electronic books, blogs, advertisements, chat sessions, social media, applications, games, and/or any other media or multimedia and/or combination of the same.

In some embodiments, the systems and methods described herein reinforce a secondary content item, by priming or warming up the user prior to the user's consumption of the secondary content item. As referred to herein, the terms “secondary content,” “supplemental content,” and “secondary content item” may be understood to mean an ad or advertisement, commercial, infomercial, and additional content that is contextually related to the media asset or a portion of the media asset. In some instances, the terms secondary content, secondary content item, and ad or advertisement are used interchangeably to include ad or advertisement, commercial, infomercial, and additional content that is contextually related to the media asset or a portion of the media asset.

The priming or warming is performed by using digital objects from the secondary content item, referred to herein as congruent objects, to search and display media assets posted on a social platform to which the user subscribes.

The content used for priming or warming varies on a scale that ranges from soft reinforcements or soft priming and warming to hard or direct reinforcements or hard priming and warming. In some embodiments, the soft reinforcements relate to using objects from the content of the secondary content item that are not the core focus of the secondary content item, e.g., not the product or service that is the subject of the secondary content item. In some embodiments, the hard reinforcements relate to using objects from the content of the secondary content item that are directly related or the core focus of the secondary content item, e.g., the product or service itself or a variation of the product or service. Other ranges in between the soft and hard reinforcements can also be used.

Conventional methods use content watched as a data gathering tool to produce ads related to that content, e.g., if a user watches content that displays a Toyota car, the data is used to suggest ads of Toyota cars. Unlike such conventional methods, some disclosed embodiments may prime or warm the user with other media assets from their contacts or third parties. These other media assets are not directly related to the core product that is subject of the originally consumed content, but instead provide a priming or warming effect that prepares the user to transition into a secondary content item that may be displayed subsequently.

In some embodiments, the priming and warming up is performed by displaying the other media assets in a social media feed on the social platform to which the user subscribes. For example, if the user subscribes to Facebook™, Instagram™, TikTok, YouTube™, LinkedIn™ or another social media platform, the other media assets are media assets that are posted on the social media platform by a contact of the user, such as a friend, a relative, a contact that is identified as a first- or second-degree contact, or a co-worker at a same or a previous company at which the user works/worked, on the social media platform.

In some embodiments, prior to determining which media assets from the user contacts, or third parties, to display for priming or warming the user, an ad server receives a notification of an interaction of the user. The interaction may be browsing of a website, consuming of a media asset, discussion with another person via the user's phone such as a phone call or text, interaction with a digital assistant, or interaction using a virtual reality device. The content of the interaction is analyzed by the ad server to determine if a product or service is disclosed in that consumed content and if the product or service is available in the marketplace for which a secondary content item can be displayed to the user.

The ad server, in some embodiments, may identify a secondary content item that is available on a social media platform to which the user subscribes and determine the various digital objects disclosed in the secondary content item. The ad server may then parse the various digital objects into a plurality of groups ranging from soft congruent object to hard or direct congruent objects. The soft and hard congruent objects, as mentioned above, are objects that are not the product or service that is the subject of the secondary content item (soft congruent objects), and objects that are directly related to or the core focus of the secondary content item (hard congruent objects). The ad server may send a recommendation to the social media server to search and find media assets from the user's contacts based on the recommended congruent objects. The communication between the ad server and the social media server may include the ad server signaling the social media server or a media asset recommendation service, via an API. Signaling may also include the ad server providing a list of labels or tags that can be used to construct a list of recommended media assets by the social media server.

In some embodiments, the social media server may analyze media assets posted on the social media platform to match them to the recommended congruent objects. These are media assets posted on the social media platform that may be generated by other users connected to the user on the platform or by premium content creators (e.g., a promotion of a video that is now available on demand, a promotion of a new TV series, a promotion of a movie that is available in theaters, etc.).

Once media assets posted on the social media platform are analyzed to determine if they include the congruent objects as recommended by the ad server, the social media server may score and rank the analyzed posted media assets for their relevance and match to the recommendations. An order of display in a social media feed, or on the social media platform, may be determined based on the scoring and ranking, and the top-ranked media asset may be presented at the top of the user's social media feed. The scoring and ranking may be associated with an identifier of the media asset such that the identifiers are ordered and organized based on the ranking. In some embodiments, relevant weights may be applied to the media assets to score and rank them for determining their order in the social media feed or display position and location on the social media platform. The ranking may be based on a label received from the ad server along with other parameters such as a value associated with a reinforcement threshold (e.g., soft reinforcement or hard reinforcement), time that the congruent object appears in the portion of the media asset, as well as its visibility (such score can be the confidence value outputted by the ML algorithm). Identifiers associated with the media assets may be transmitted such that the identifiers may be used to fetch the media asset when it is to be displayed.

In some embodiments, the display of the top media asset in the social media feed may include providing the media asset for preview, playing a portion of the media asset automatically, highlighting portions of the media asset, or enhancing the highest-ranked media asset or a portion of the media asset to make it attractive and easily visible to the user. Although displaying in a social media feed is described, the embodiments are not so limited and display in a “For You” page of the social media platform or display at other locations are also contemplated.

In some embodiments, the systems and methods may track a user's media consumption and use the input received by the ad server from such consumption as a basis for identifying a relevant secondary content item, determining the congruent objects of the secondary content item, and providing a recommendation to the social media server for identifying media assets that can be used to prime the user. In other embodiments, the systems and methods may track a user's consumption relating to website browsing, online shopping cart or basket interactions, previous purchases, and digital assistant interaction, to name a few.

With respect to online shopping carts, it is common for users to add items to their cart on an eCommerce website or phone application and then exit the website without completing a purchase. In some cases, users might be hesitant to buy what they added to their shopping cart because they might feel they need to research the products more or read reviews, etc. As such, the embodiments disclosed herein can be used to reassure the user by selecting portions of content related to the items in the cart, including media assets generated or uploaded to the social network by the user's contacts. For example, the ad server may recommend to the social media server, based on a plurality of parameters, to select a media asset that features a friend of the user (e.g., a contact that the user follows on the social network) who is performing an action that is related to the secondary content item. These friends' media assets may be retrieved by the social media server based on tags/labels associated with these media assets.

In some embodiments, the media assets may be manipulated and enhanced to highlight a congruent object displayed in the media asset. For example, the enhancing may include zooming in on or highlighting a congruent object of interest. In some embodiments, zooming, highlighting, or other enhancements may occur in response to instructions from the ad server. Specific portions of longer media assets (that feature the congruent object or topic of interest) can be selected for auto play, since the user might not select all the media assets that were recommended to them for viewing.

In some embodiments, the weights or parameters for media assets that are posted on the social media platform may be used to determine the order of the media assets in a social media feed. The weights may indicate the matching strength between a media asset and the recommendations received from the ad server.

With respect to previous purchases, in some embodiments, the ad server may receive an input of a previously purchased product or service. The ad server may identify a secondary content item on a social media platform that relates to the purchased product or service and identify congruent objects in the identified secondary content item. The ad server may provide recommendations to the social media server based on the identified congruent objects. The social media server may analyze media assets posted by contacts of the user based on the recommendation and determine their order in the user's social media feed.

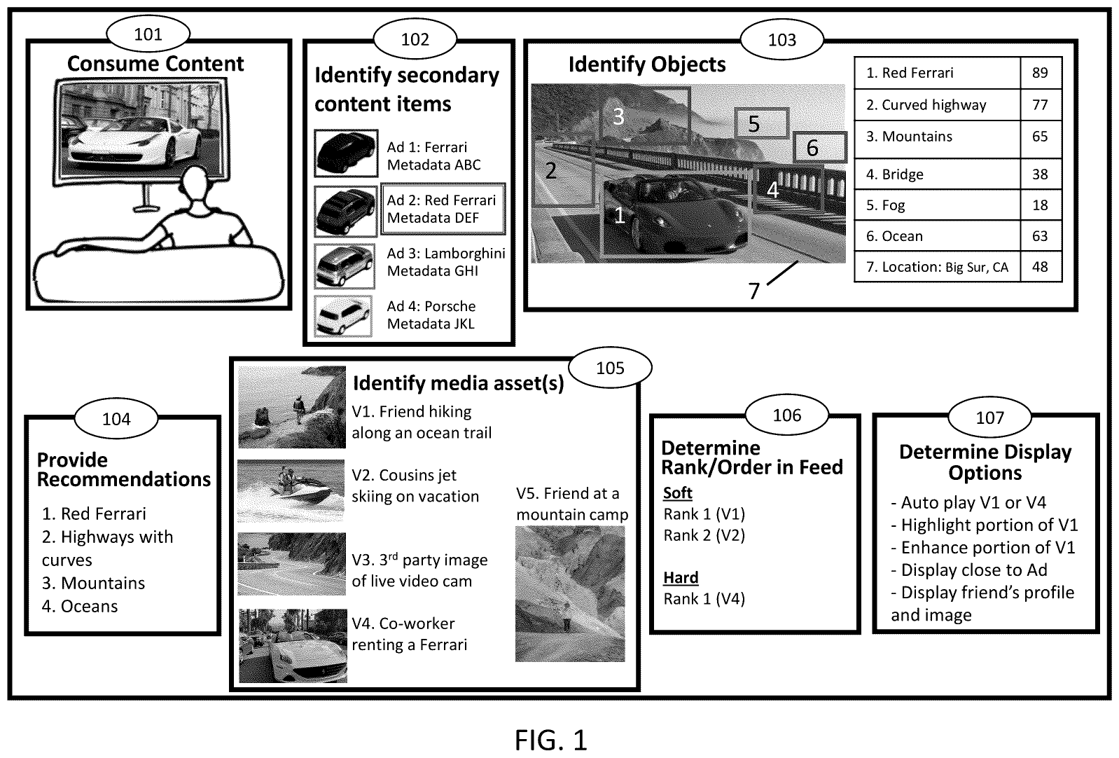

FIG. 1 is a block diagram of an example of a process for identifying media assets posted on a platform and determining their order of display in a social media feed based on shared congruent objects between the media assets and a secondary content item, in accordance with some embodiments of the disclosure.

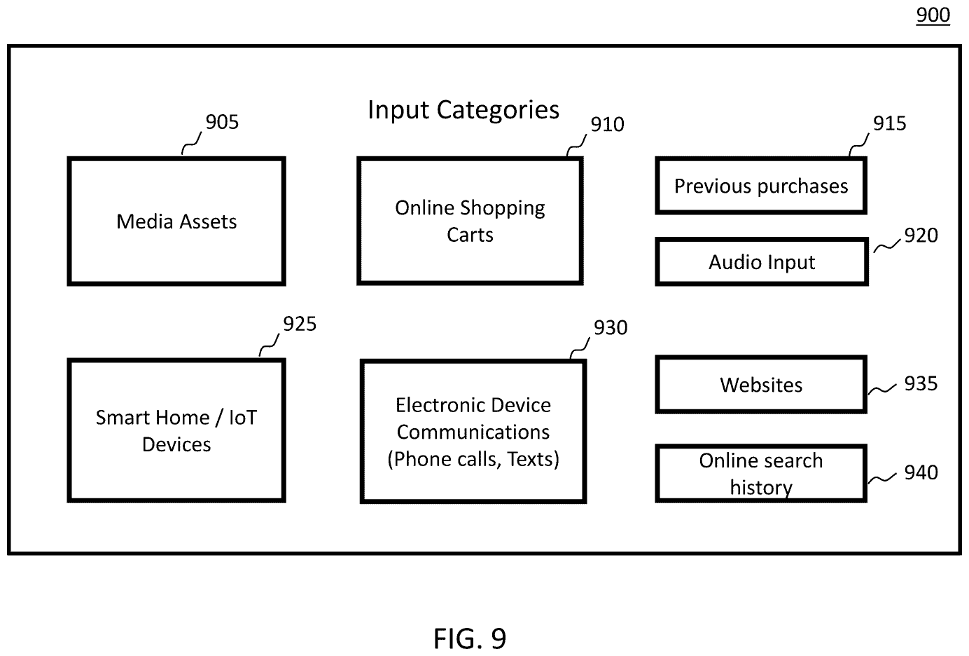

In some embodiments, as depicted at block 101, a determination is made that a user has interacted with some content. The interaction may be of a variety of types. For example, the interaction may include browsing of a website; consuming of a media asset; discussion of a product, service, or topic with another person via the user's phone, such as a phone call or text; composing or receiving an email; interaction with a digital assistant; interaction using a virtual reality device; placement of items in an online shopping cart; browsing of products in an online shopping cart; prior purchases of products or services; and/or other interactions from input categories as described below in reference to FIG. 9.

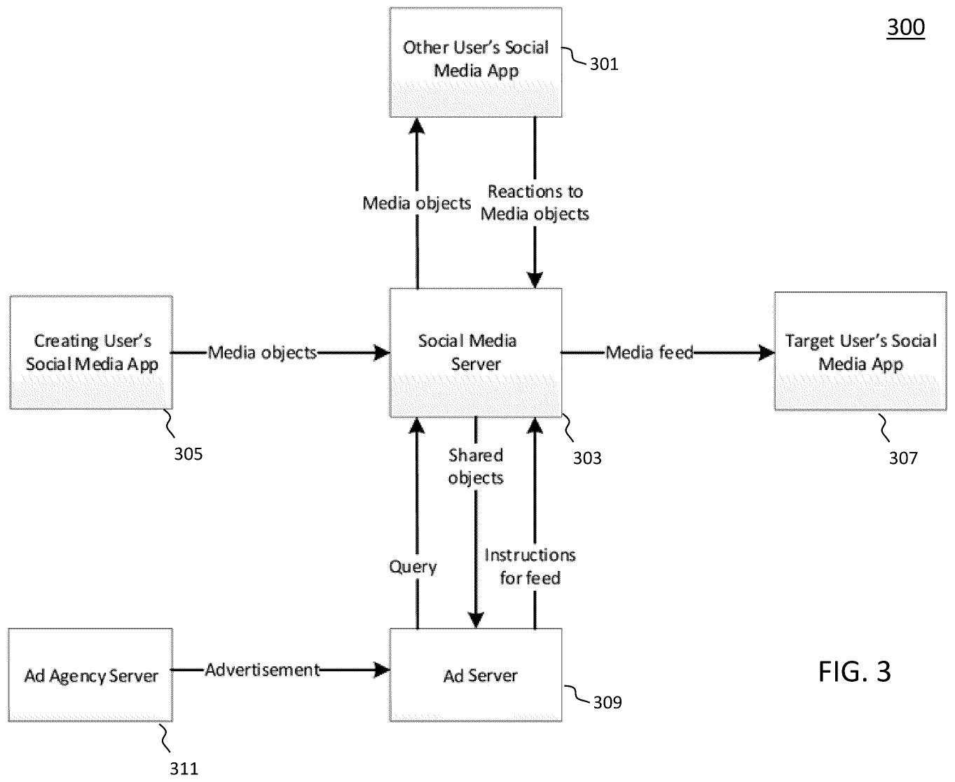

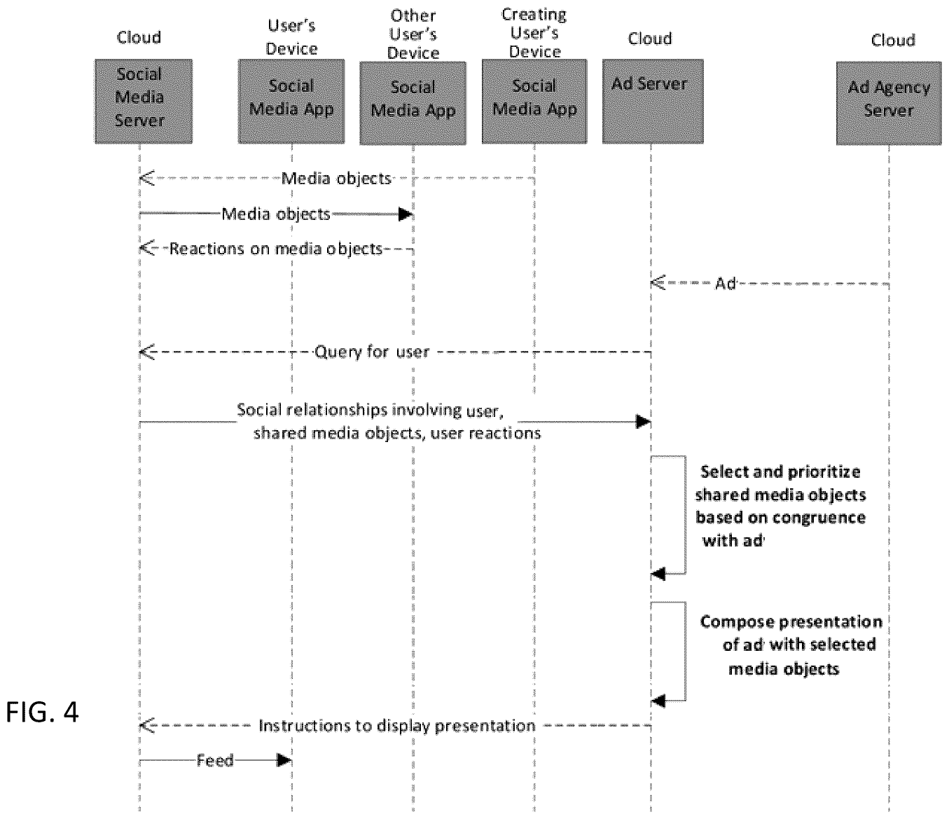

In some embodiments, an ad server, such as the ad server depicted in FIGS. 3 and 4, may receive an indication of the user's interaction with the content, e.g., that the user has consumed a media asset on a media device, the user has browsed a product on a specific website, the user has entered a search query in a search engine looking for a specific product or service, etc.

In response to receiving an indication that the user has consumed or interacted with content, the system, which may include an ad server, at block 102 may analyze the content consumed to identify products or services associated with the consumed content. For example, the ad server may analyze the content consumed to determine one or more products that are displayed in the content. The ad server may also determine if the products or services identified in the content are available in the marketplace and if a secondary content item related to the product or service displayed in the content is available for display. In some embodiments, the ad server may determine the secondary content item is available for display on a social media platform to which the user is subscribed.

As depicted in block 102, in one embodiment, the ad server may identify a plurality of secondary content items that are available to be displayed to the user on a platform, such as a social media platform, to which the user subscribes. In other embodiments, the ad server may identify a plurality of secondary content items that are available on a database or through a service that can be transmitted to a server associated with a platform to which the user subscribes such that the transmitted secondary content item can be displayed on the platform. In this example, assuming the content consumed by the user in block 101 relates to a red Ferrari™, the ad server identifies the following four secondary content items: 1) a blue Ferrari secondary content item, which includes metadata ABC, 2) a red Ferrari secondary content item, which includes metadata DEF, 3) a Lamborghini™ secondary content item, which includes metadata GHI, and 4) a Porsche™ secondary content item, which includes metadata JKL. The secondary content items may be identified based on relevance between the content consumed and the secondary content items that are the most relevant to the content. Since the content consumed is a red Ferrari, the ad server may determine secondary content items relating to Ferraris and other sports cars may be of interest to the user and as such identify if secondary content items related to such sports cars are available for display. In the event a red Ferrari secondary content item is not available, the ad server may identify other-colored Ferrari secondary content items as the next best secondary content items for display.

As depicted in block 102, in this example, the ad server identifies the availability of a red Ferrari secondary content item. The ad server may have performed a metadata search or a graphical search to determine if such a secondary content item was available and identify it for display.

Once the secondary content item for display has been identified, in one embodiment, as depicted in block 103, the ad server identifies objects displayed in the content of the secondary content item. These objects, also referred to herein as congruent objects, are digital objects displayed in the secondary content item over the course of the secondary content item's timeline. The secondary content item is either a video or a still image of a product, and the congruent objects include digital objects that are both the core focus of the secondary content item as well as digital objects that are displayed in the secondary content item but are not the core focus of the secondary content item. In this example, as depicted in block 103, the ad server identifies a secondary content item for a red Ferrari that includes congruent objects a) red Ferrari, b) a curved highway c) mountains in the backdrop, d) a bridge, e) fog, f) an ocean, and g) the location of the secondary content item being Big Sur, California.

In some embodiments, the ad server may analyze the congruent objects of the secondary content item and place them into categories or tag or label them. These categories, tags, or labels may range from soft to hard priming or warming categories. The soft categories or tags may be associated with those congruent objects that are not the core focus of the secondary content item, such as mountains, bridge, ocean, etc. These soft categories provide the backdrop to the core product displayed in the secondary content item, which is the red Ferrari, and as such do not jump out at the user as a direct hard sale of a product. On the other hand, the red Ferrari may be tagged or categorized as a hard congruent object, i.e., an object that is the core focus of the secondary content item and the main object that is offered for sale in the secondary content item. The ad server may utilize image processors and artificial intelligence (AI) engines and associated AI algorithms to determine which congruent objects are soft, hard, or somewhere in between.

In one embodiment, one of the goals, of some of the embodiments disclosed herein, is to determine how to prime or warm up a user by displaying warming content, such as a video or other content, prior to the user being exposed to or consuming the secondary content item. As such, the system may determine the level or priming and warming on a scale that ranges from a soft sell to a hard sell. The congruent objects categorized, tagged, or labelled as soft, hard, or in between are used in determining the types of media assets and content that can be used to warm up the user. For example, a soft warming up, considering the Ferrari example, may include identifying a media asset that depicts an ocean or a highway with curves that is posted by a friend of the user on a social platform and displaying the warming media asset prior to the user's consumption of the identified secondary content item that includes the red Ferrari. Such warming up includes congruent elements of the secondary content item without showing the Ferrari itself.

Continuing with the description of block 103, the ad server may score the objects identified in the secondary content item. For example, the ad server may score the congruent objects based on their relationship to the core focus of the secondary content item. Since the secondary content item is focused on selling a red Ferrari, congruent object 1, the red Ferrari, is scored the highest at 89 since its directly related to the product being sold. If other sports cars were included in the background, they would also score high since they are related to the category of sports cars but not as high as the focused product of the secondary content item, the red Ferrari. In other embodiment, the ad server may only identify the congruent objects and transmit the metadata or identifiers relating to the identified congruent objects to a separate server or engine, such as a social media server or an AI engine for determining their use.

At block 104, the ad server may signal to a media asset recommendation service, such as a social network recommendation system, via an API. The signaling may provide metadata relating to the identified congruent objects such as the media asset recommendation service may analyze the congruent objects to determine the content type that they would like to target on a platform on which the user is subscribed.

In another embodiment, the ad server may directly signal a social media server that is associated with a social media platform to which the user is subscribed. The ad server may provide its recommendations through the signaling, where the signaling includes recommendations that can be used by the social media server in identifying media assets that can prime or warm the user prior to the user's consumption of the identified secondary content item in block 102 and 103.

Although mentions of ad server and social media server are described, the embodiments are not so limited. For example, in one embodiment, the ad server and the social media server may be separate servers, and in other embodiments, the functionalities of the ad server and a social media server be combined in one server. In yet other embodiments, other servers in addition to the ad server and a social media server may be used.

At block 104, the recommendations, regardless of if they are provided by an ad server, a media asset recommending service, or determined by the social media server itself, are used by the social media server in identifying media assets posted on the platform. In one example, if the recommendation is to use a hard sales approach, i.e., recommendation to identify media assets that are directly related to the product being sold in the secondary content item, then, as depicted in block 104, the ranking order of recommendations may be 1. sports cars, 2. highways with curves, 3. mountains, and 4. oceans, all of which are congruent objects from the identified secondary content item in blocks 102 and 103. In another example, if the recommendation is to use a soft sales approach, i.e., recommendation to identify media assets that do not show objects that are the core focus of the secondary content item, then the ranking order of recommendations may be the opposite of the recommendations listed in block 104. For example, sports cars may be lower in order than other congruent objects that are not directly related to the product being sold.

At block 105, based on the soft or hard sales approach used, the social media server may identify media assets posted on its platform by friends or contacts of the user or from professional content creators that are related to the congruent objects identified in the recommendations.

As depicted, in one embodiment, at block 105, the social media server identified a plurality of media assets that are related to the congruent objects identified. These media assets include media asset V1, which is posted by a friend of the user on the social media platform. The media asset depicts the user's friend hiking along an ocean trail. Since “ocean” is one of the congruent objects recommended in block 104, the social media server identifies the media asset such that it can be used to prime or warm up the user to scenery of the ocean that is similar to the scenery shown in the Ferrari secondary content item.

As depicted, in one embodiment, at block 105, the social media server identified media asset V2, which is posted by the user's cousin on the social media platform. The media asset depicts the user's cousin while he is jet skiing in the ocean while on vacation. Since “ocean” is one of the congruent objects recommended in block 104, the social media server identifies the media asset such that it can be used to prime or warm up the user to scenery of the ocean that is similar to the scenery shown in the Ferrari secondary content item.

In some embodiments, in addition to, or in lieu of, identifying congruent objects from the secondary content item, as depicted in block 103, the recommendation may also identify attributes and emotions associated with the core product in the secondary content item. These attributes or emotions may be used in identifying media assets on the social media platform. For example, “speed,” “thrill,” “excitement,” and “adrenaline” may be identified as attributes and emotions since they relate to a person's likely emotions and experiences while driving a Ferrari at a high speed on a curved highway. Accordingly, the social media server may identify the cousin's posted media asset of jet skiing in the ocean while on vacation since it also has similar attributes and emotions of “speed,” “thrill,” and “excitement,” while speeding on the jet ski in the ocean.

In some embodiments, a recommendation may be for an attribute that is not displayed as a congruent object in the secondary content item. For example, if the secondary content item is focused on a cold soft drink, such as Pepsi™ or Coca Cola™, the ad server may recommend that a media asset that displays a hot summer day, heat, or an exercise or workout of people sweating, or a fast-paced game being played, such as basketball, be used to prime or warm up a user to the secondary content item featuring a Pepsi™ or Coca Cola™. The ad server using an AI engine may determine that media assets posted by the user's contacts or by professional content creators that feature such attributes (e.g., hot summer day, heat, or an exercise or workout of people sweating, or a fast-paced game being played, such as basketball) create a feeling, desire, or sensation in the viewer of wanting to drink something cold and thirst quenching. As such, the media assets may be used to prime or warm up the user to a secondary content item that may be presented for consumption that includes the cold Pepsi™ or Coca Cola™.

As depicted, in one embodiment, at block 105, the social media server identified a media asset V3, which is posted by a third party on the social media platform. The media asset depicts a live video cam of a highway at a location as it curves around a mountain such that drivers are aware of road conditions at the location. Since “curved highway” is one of the congruent objects recommended in block 104, the social media server identifies the media asset such that it can be used to prime or warm up the user to curved highways prior to the user being exposed to the Ferrari secondary content item, which shows the Ferrari being driven at a high speed on a curved highway. Such priming and warming up, in one embodiment, is used to create a reinforcement effect on the user who, subsequent to consuming the priming media asset V3, consumes the secondary content item with the Ferrari being driven at a high speed on a curved highway. In other words, repetition of similar media assets is used to warm up the user such that when they see the Ferrari secondary content item it resonates better due to familiarity. Priming and warming up media assets, in another embodiment, are aimed at creating a desire or sensation in the user of wanting to see more media assets with similar scenery. When similar scenery is depicted, such as in the Ferrari secondary content item, it is a continuation of the earlier created sensation or desire.

As depicted, in one embodiment, at block 105, the social media server identified media asset V4, which is posted by the user's co-worker on the social media platform. The media asset depicts the user's co-worker driving a yellow Ferrari on a street. Since “sports car” and “Ferrari” have been identified as congruent objects recommended in block 104, the social media server identifies the media asset because it's directly related to the core focus of the secondary content item and also to the recommended congruent object. If the recommendation is to prime the user with a hard sell, then such a media asset that directly relates to the product of the secondary content item may be used.

Lastly, as depicted, in one embodiment, at block 105, the social media server identified video V5, which is posted by the user's friend on the social media platform. The media asset depicts the user's friend walking through a mountain area. Since “mountains” were identified as a congruent object in the secondary content item of block 103 and recommended in block 104, the social media server identifies the media asset such that it can be used to prime or warm up the user to scenery of the mountains that is similar to the scenery shown in the Ferrari secondary content item having the backdrop of the mountains.

At block 106, the media assets identified at block 105 may be ranked. The ranking may be used to determine the order of display of the media assets in a social media feed on the social media platform to which the user subscribes. The media assets that are the most relevant, depending upon whether the strategy is prime and warm the user to the secondary content item in a soft or a hard manner.

As depicted in block 106, if the recommendation is to softly prime or warm up the user, then media asset V1 would be ranked as Rank 1 and media asset V2 would be ranked as Rank 2. Since V1 and V2 depict friends hiking on an ocean trail and jet skiing, they include the congruent objects of the secondary content item, i.e., ocean and mountains (and the emotion created by speed). The media assets V1 and V2, however, do not include congruent objects that may be categorized as a hard or direct relation to the product being sold in the secondary content item, and, as such, are deemed to be a softer type of priming and warming up.

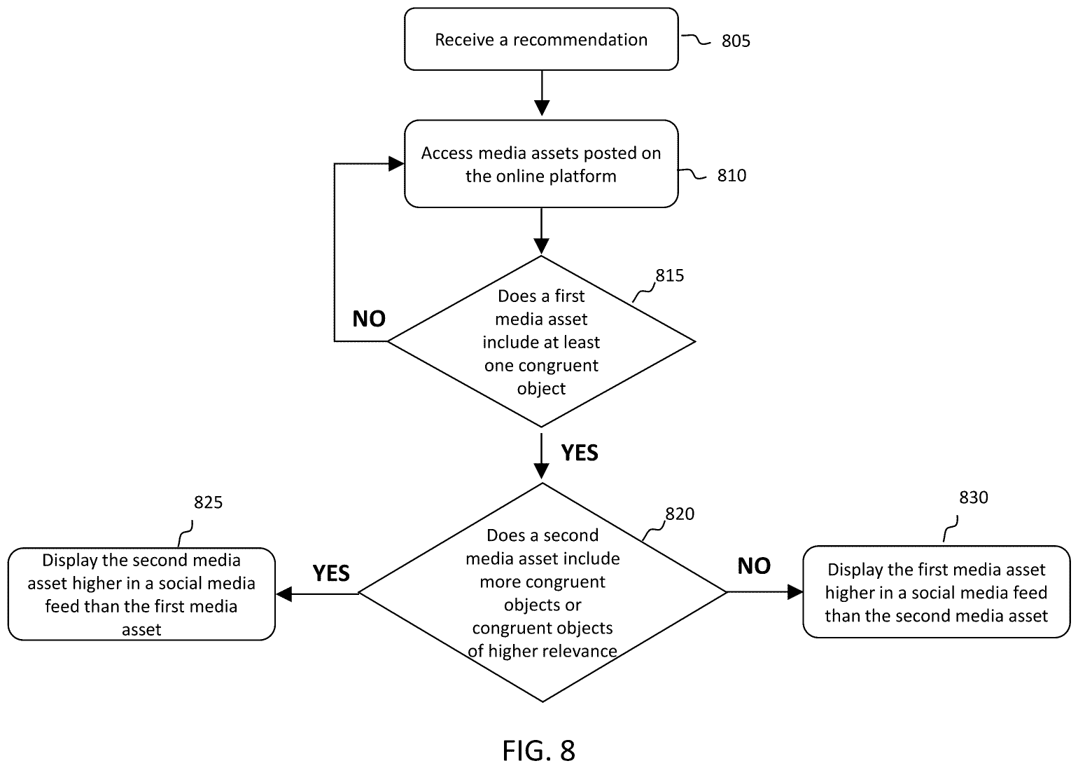

As depicted in block 106, if the recommendation is to do a hard sell or a hard or direct prime or warm up, then media asset V4 would be ranked as Rank 1. Since V4 depicts a Ferrari, albeit a yellow one instead of a red Ferrari displayed in the secondary content item, it is directly related to the product of sale in the secondary content item. A determination on which media assets to rank higher in the social media feed may be made at block 104 or block 106. Further description relating to ranking of the media assets and their priority in a social media feed is provided below in reference to the description of FIG. 8.

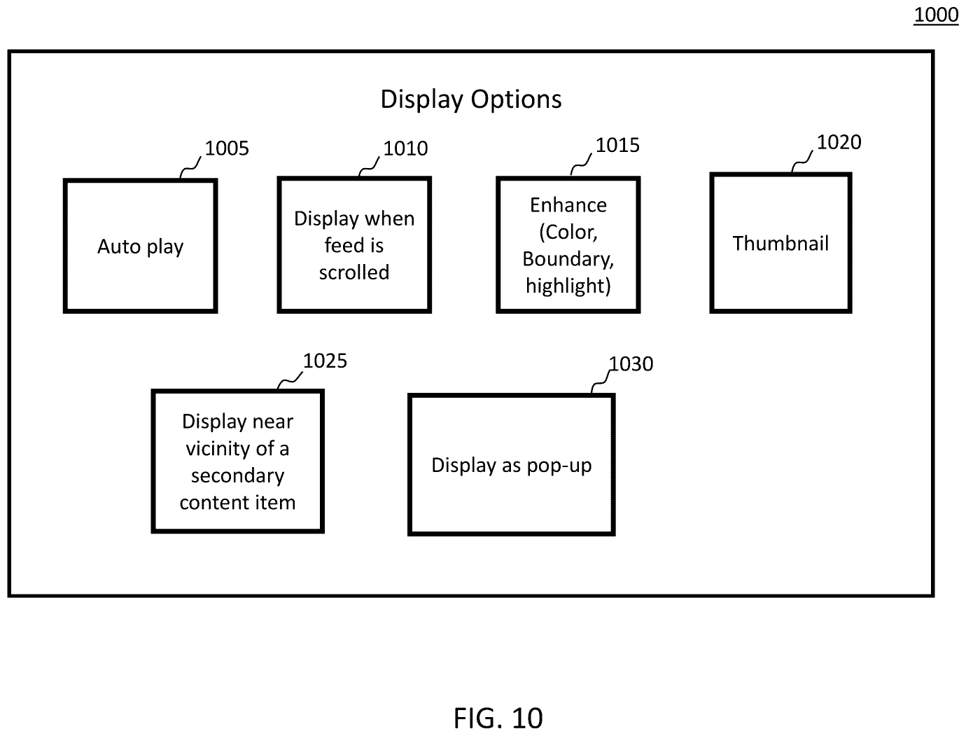

At block 107, the social media server may determine a display option for the media assets that were ranked in block 106. The social media server may select an option from any one or more display options described in the description related to FIG. 10. For example, these display options may include automatically playing the highest-ranked media asset, highlighting a portion of the highest-ranked media asset, enhancing a portion of the highest-ranked media asset, displaying the highest-ranked media asset within a threshold distance on the video interface to where the secondary content item is displayed, or displaying the highest-ranked media asset along with the friend's profile that is posting the media asset next to the highest-ranked media asset.

In some embodiments, display options, including enhancements such as zooming or highlighting of the media assets, may be directed by the ad server. For example, based on the recommendation to use either a soft or a hard prime and warm up approach, the ad server may determine the type of display and enhancement option that correlates with the retarget aggressiveness (soft or hard).

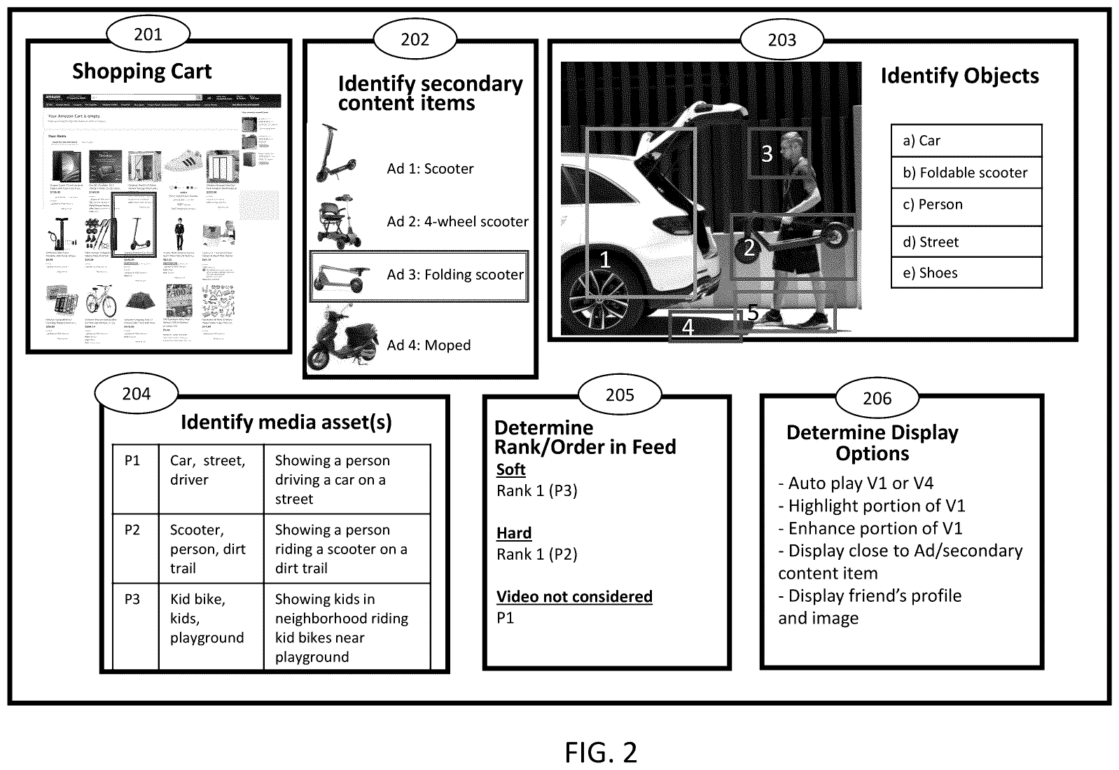

FIG. 2 is a block diagram of another example of a process for identifying media assets posted on a platform and determining their order of display in a social media feed based on shared congruent objects between the media asset and a secondary content item, in accordance with some embodiments of the disclosure. Although displaying in a social media feed is described, the embodiments are not so limited and display in a “For You” page of the social media platform or display at other locations are also contemplated.

In some embodiments, as depicted at block 201, an ad server receives an indication of a user interacting with an online shopping cart. The user may have either selected an item on the shopping website, entered a search query on the shopping website, placed the item of interest that the user intends to buy in their shopping cart, selected the item but then abandoned the website or the shopping cart, hovered over the item displayed on the shopping website, or gazed at the product displayed on the shopping website. The user may have performed other actions that can be associated with the user having an interest in an item displayed in the shopping cart.

In response to receiving an indication that the user has interacted with an item on the shopping website, the ad server, at block 202, may analyze the item of interest, which in this example is a scooter, and identify related secondary content items on a social media platform to which the user subscribes.

As depicted in block 202, the ad server may identify a plurality of secondary content items that are available for display on the social media platform or website that relate to the item of interest determined based on the user's interactions on the shopping website. In this example, the ad server identifies the following four secondary content items: 1) a scooter, 2) a 4-wheel scooter, 3) a folding scooter, and 4) a moped.

The secondary content items may be identified based on relevance between the scooter of interest on the shopping website and the content displayed in the secondary content item. Once the secondary content item for display has been identified, in one embodiment, as depicted in block 203, the ad server identifies congruent objects displayed in the content of the secondary content item. In this example, as depicted in block 203, the ad server identifies congruent objects a) car, b) foldable scooter, c) person, d) street, and e) shoes. It may also identify additional congruent objects.

In some embodiments, an artificial intelligence (AI) engine that executes an AI algorithm may be used to identify the congruent objects. The AI engine may analyze the congruent objects to determine their relevance to the product or service that is the main focus of the secondary content item. For example, although congruent objects car, foldable scooter, person, street, and shoes have been identified by the ad server, the AI engine may determine that a car or shoes may bear little relevance to the product or service being sold, which is the scooter. In another embodiment, the portability of a scooter may be important and showing that a scooter can be folded and placed in the trunk of the car may be deemed to be relevant.

At block 204, the ad server may signal to a media asset recommendation service or a social media server via an API and provide the list of congruent objects identified earlier at block 203. The signaling may provide metadata relating to the identified congruent objects to the social media server. The metadata along with a reinforcement goal, such as a soft or a hard reinforcement, may be analyzed together to determine which media assets to search for on the social media platform and subsequently in which order in the social media feed to display the media assets from the search results.

As depicted in block 204, the social media server identified three media assets that were posted on the social media platform as media assets that may be used as warming up media assets. These media assets include media asset P1 that includes congruent objects car, street, and driver and the context of the media asset is a person driving a car on the street. The AI engine may determine that the car, street, and driver by themselves are not relevant to the secondary content item even when a soft reinforcement approach is taken, since the combination of the congruent objects does not meet a minimum threshold to prime or warm a person. As such, the media asset P1 may not be used by the social media server as a priming or warming media asset for the secondary content item.

Media asset P2 is another media asset from the media assets identified by the social media server. Media asset P2 includes congruent objects scooter, person, and dirt trail. The AI engine may determine that the objects scooter, person, and dirt trail meet the relevance threshold to the secondary content item since there are some common congruent objects in both, and the congruent objects bear some relevance to the secondary content item. For example, the scooter, although not shown on the street but on a dirt road instead, is directly related to the scooter in the secondary content item of block 203 and as such deemed relevant.

Media asset P3 is another media asset from the media assets identified by the social media server. Media asset P3 includes congruent objects kid bike, kids, and playground and the context of the media asset shows kids riding kid-size bikes near a playground. Since bikes have some similar attributes to scooters, e.g., two wheels, the AI engine may determine them to be relevant to scooters.

Depending upon the soft or hard reinforcement approach selected, at block 205, media asset P3 may be shown at the top of the social media feed if a soft approach is selected, and media asset P2 may be shown at top of the social media feed if a direct or hard reinforcement approach is selected.

At block 206, a variety of display options from the display options provided in FIG. 10 may be selected.

Although various processes have been described in reference to FIGS. 1 and 2 that relate to embodiments where the user is consuming a media asset or interacting with a shopping website, the embodiments are not so limited, and other input categories as described in FIG. 9 are also contemplated. For example, the input category may be previous purchases that are examined by the ad server to determine which secondary content item to identify and then determine congruent objects from the identified secondary content item to signal to the social media server. The social media server in return may determine which media assets posted on the platform include the congruent objects and determine their order in the social media feed.

In some embodiments, the blocks and sequence of the blocks discussed in FIGS. 1 and 2 are interchangeable, and a different sequence of steps may also be performed to determine which media assets to display and their order in the social media feed. Likewise, the blocks relating to determining congruent objects that are shared between a posted media asset on the social media platform and the secondary content item may be determined by an ad server. It may be done by the ad server querying the social media server for media assets that include the congruent objects and, in response to receiving the search results of the query, composing a presentation that includes the media assets from the search results.

In this embodiment, the social media server may receive media assets from contacts of the user or from professional content creators. The media assets may be shared with the user via a social media application hosted by the social media server. The social media server may provide the shared media assets to its users (in the role of a user's contact) through the social media application. Upon sharing or posting the media assets in feeds of a plurality of users, the social media server may receive reactions, such as comments, “likes,” and “dislikes,” via the social media app.

In some embodiments, an ad server that is communicatively connected to the social media server may receive a secondary content item. The secondary content item, or an identifier of the secondary content item, may be transmitted to the ad server from an ad agency along with a description of the target user. In other embodiments, the secondary content item may be generated by the ad server.

In response to receiving the secondary content item, in some embodiments, the ad server may query the social media server for media assets shared with the user. These include media assets such as media assets posted by the user's friends and other contacts as well as media assets that were created by content creators and shared with the user. In response to the query, the social media server may search through the media assets, e.g., media assets, shared with the user and identify those media assets that share congruent objects with the secondary content item.

In some embodiments, the ad server may compose a presentation of the secondary content item with the selected shared congruent objects. The ad server may then signal or instruct the social media server to incorporate the composed presentation in its feed to the user. The social media server may then include the composed presentation in the social media feed to the user, such as by displaying it at the top of the social media feed and using one of the display options provided in FIG. 10. Although displaying in a social media feed is described, the embodiments are not so limited and display in a “For You” page of the social media platform or display at other locations are also contemplated.

Although FIGS. 1 and 2 have been described with respect to blocks 101-107 and 201-206, the processes described can also be performed as described in flowcharts of FIGS. 4, 7A, 7B, and 8.

FIG. 3 is a block diagram of an exemplary system for identifying media assets posted on a platform and determining their order of display in a social media feed based on the media assets shared congruent objects with a secondary content item, in accordance with some embodiments of the disclosure.

In some embodiments, system 300 may be used to perform the processes described in FIGS. 1-2, 7-8, and 14. The system includes a user's social media application, a social media server, a creating user's social media application, a consuming user's (also referred to as the user or target user) media application, an ad server, and an ad agency server. The system may also include more or fewer devices, applications, and servers that may collectively provide the functionality discussed below.

In some embodiments, the social media server performs various functions relating to the operation of a social media platform. These functions include (1) representing accounts for various users, (2) receiving media assets from the various users and displaying them in a social media feed, (3) transmitting social media feeds containing shared media assets and secondary content items, and (4) receiving user's reactions to the transmitted or displayed media assets in the social media feeds. The social media server also performs other functions such as keeping a record of each user's contacts, updating a social media feed for a user, and displaying comments, “likes,” and “dislikes” posted by other users.

In some embodiments, the user may use an electronic device, such as a mobile phone, a laptop, or another wireless device, to connect to a social media platform to which they are subscribed. The electronic device may include an option to download a social media app (which could be a separate app or realized in a media browser). The social media app may allow the user to consume media assets, such as videos, and share content, such as media assets, on the social media platform or website. The user may also share or consume pictures, videos, and texts, or make or listen to audio recordings. They may also download or upload media assets and edit them.

In some embodiments, an ad server 309 is communicatively connected to a social media server 303. In some embodiments, the ad server and the social media server may be separate servers, and in other embodiments, the functionalities of the ad server and a social media server may be combined in one server. In yet other embodiments, other servers in addition to the ad server and a social media server may be used.

Although they can be combined in one server, for the sake of describing their distinct roles, the ad server and social media server are described separately herein. In some embodiments, the ad server 309 receives a secondary content item from an ad agency server 311 along with a description of a potential user. The ad server also receives media assets that are shared by the user's contacts or a professional content creator, which are shared with the user and posted on a social media platform. The receiving of such shared media assets may be via the social media server 303. The ad server selects media assets having congruent objects that are shared with the secondary content item as described in blocks 103-105 and 203-204 in FIGS. 1 and 2 above. In some embodiments, the ad server composes the secondary content item with the selected shared congruent objects, and in other embodiments, the ad server identifies a secondary content item that already exists and includes the shared congruent objects. The ad server then signals or instructs the social media server to display the composed presentation as part of the user's media feed. The ad agency server transmits ads (along with descriptions of potential users that may consume the secondary content item) to the ad server.

FIG. 4 is a block diagram of communications between different components of the system to identify media assets posted on a platform and determine their order of display in a social media feed based on the media assets' shared congruent objects with a secondary content item, in accordance with some embodiments of the disclosure.

In some embodiments, the communications between social media server, social media applications of both the consumer and the content creator, ad server, and ad agency server may occur to identify media assets posted by users that share congruent objects with the secondary content item such that they can be moved up in the order of a social media feed.

As depicted in FIG. 4, the social media server may receive media assets from contacts of the user or from professional content creators. This may be via a creating user's social media app that is on their electronic device. These media assets may be media assets of the user's contact, such as videos they took with their mobile phones, e.g., during a vacation, or some other activity in which the user's contact may also be displayed.

Upon receiving the media assets, e.g., videos, the social media server may share the media assets on the social platform by posting them into the social media feeds of the user's contacts. In one embodiment, the social media server may provide the shared media assets to its users (in the role of a user's contact) through the social media application. Upon sharing or posting the media assets in feeds of a plurality of users, the social media server may receive reactions, such as comments, “likes,” and “dislikes,” via the social media app.

As depicted in FIG. 4, an ad server that is communicatively connected to the social media server may receive a secondary content item. The secondary content item may be transmitted to the ad server from an ad agency along with a description of the target user. In other embodiments, the secondary content item may be generated by the ad server.

In response to receiving the secondary content item, in some embodiments, the ad server, such as the ad server 309 in FIG. 3, may query the social media server for media assets that have been shared with the user. These include media assets such as videos posted by the user's friends and other contacts as well as media assets that were created by content creators and shared with the user. In response to the query, the social media server may search through the media assets of the user that have a relationship with the user, e.g., the user's friends and contacts, shared media assets, and user reactions.

In some embodiments, the social media server may share the media assets from the search results of the query with the ad server. The ad server may then select and prioritize the shared media assets based on congruence with the secondary content item. Since the prioritized media asset are to be used as a priming or warming up media asset prior to the consumption of the secondary content item, the ad server may apply either a soft or a hard or direct reinforcement approach for prioritizing.

As discussed above, in some embodiments, the soft reinforcement approach may be associated with those congruent objects that are not the core focus of the secondary content item, i.e., not the product being sold in the secondary content item. In some embodiments, hard or direct reinforcement approach may be associated with those congruent objects that are the core focus of the secondary content item or closer to the core focus of the secondary content item with a variation that is within a variation threshold. For example, if the secondary content item is selling a red Ferrari, then using a media asset posed by a user's friend that has a congruent object that is a red Ferrari would be using a direct or hard reinforcement approach. If the media asset posted by the user's friend is a different-colored Ferrari or another sports car, that would be within the variation threshold as they are also closely related to the red Ferrari and as such will be considered to be applying a hard reinforcement approach. The ad server may utilize image processors and artificial intelligence (AI) engines and associated AI algorithms to determine which congruent objects are soft, hard, or somewhere in between.

In some embodiments, the ad server may compose a presentation of the secondary content item with the selected shared congruent objects. The ad server may then signal or instruct the social media server to incorporate the composed presentation in its feed to the user. The social media server may then include the composed presentation in the social media feed to the user, such as by displaying it at the top of the social media feed and using one of the display options provided in FIG. 10.

In other embodiments, the ad server may identify a secondary content item based on what a user has already consumed. The ad server may get an indication of the content consumed by the user, and in response, the ad server may identify a secondary content item that is related to the consumed content. In some embodiments, the ad server may obtain the secondary content item from an ad placement agency. The ad server may then determine the congruent objects of the selected secondary content item and send a recommendation to a social media server based on either a soft or a hard reinforcement approach. The social media server may receive the recommendation of congruent objects, based on the reinforcement approach applied, and identify media assets posted by either the user's contacts or content creators. Once media assets are identified, the social media server may rank the media assets based on their relevance to the congruent objects and determine their order in a social media feed of the user with the most relevant being displayed at the top of the social media feed. The social media server may also determine the display options for the media assets posted on the top of the social media feed, such as auto play, enhance, or other options listed in FIG. 10.

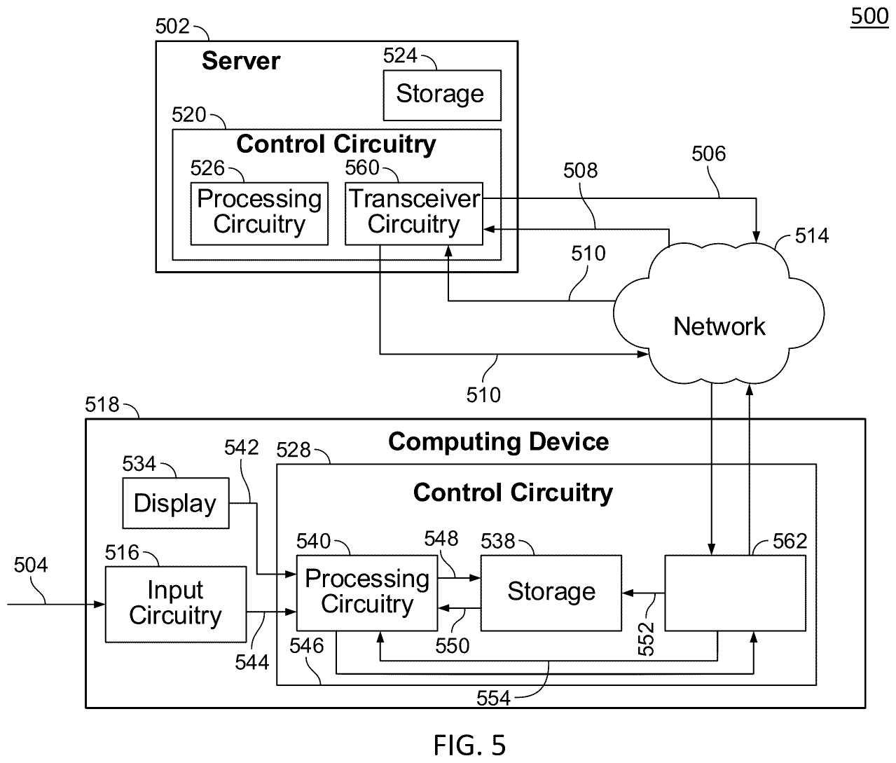

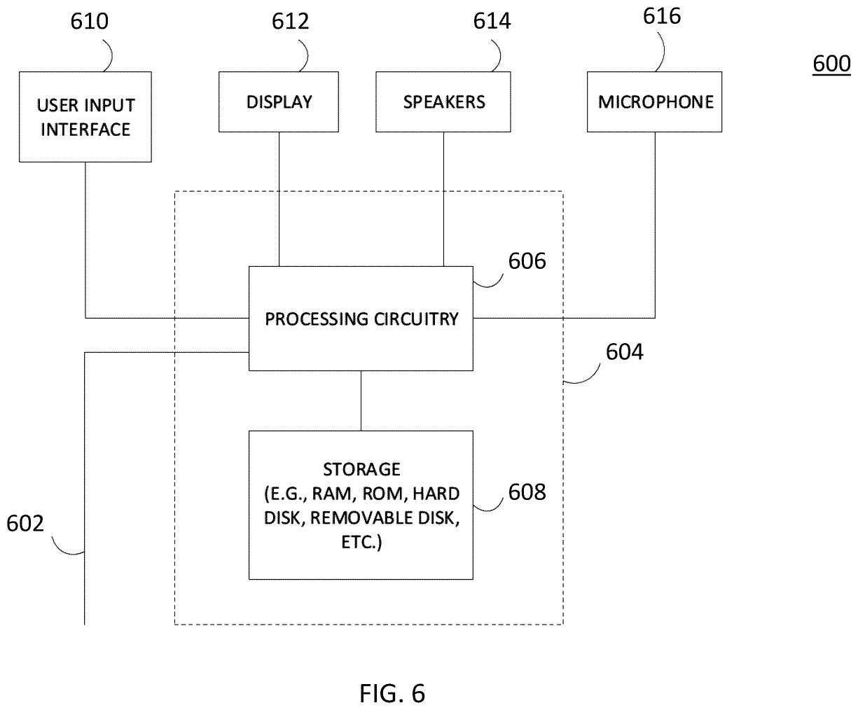

FIG. 5 is a block diagram of a system, in accordance with some embodiments of the disclosure and FIG. 6 is a block diagram of a media/display device, in accordance with some embodiments of the disclosure. FIGS. 5 and 6 also describe exemplary devices, systems, servers, and related hardware that may be used to implement processes, functions, and functionalities described in relation to FIGS. 1-4, and 7A-14. Further, FIGS. 5 and 6 may also be used for comparing congruent objects in media assets posted on a social media platform to recommendations provided by an advertisement server, scoring the posted media assets based on their relevance to the recommendations, and determining their display on the social media platform, such as in a social media feed or a “For You” page, based on the recommendation, which may range from soft to hard, or low to high priming and warming up. FIGS. 5 and 6 may also be used for identifying relevant media assets posted on a social platform and using them to warmup, prime, or engage a user prior to their consumption of an identified secondary content item, such as an advertisement, and all other processes and features described herein.

In some embodiments, one or more parts of, or the entirety of system 500, may be configured as a system implementing various features, processes, functionalities and components of FIGS. 1-4, and 7A-14. Although FIG. 5 shows a certain number of components, in various examples, system 500 may include fewer than the illustrated number of components and/or multiples of one or more of the illustrated number of components.

System 500 is shown to include a computing device 518, a server 502 and a communication network 514. It is understood that while a single instance of a component may be shown and described relative to FIG. 5, additional instances of the component may be employed. For example, server 502 may include, or may be incorporated in, more than one server. Similarly, communication network 514 may include, or may be incorporated in, more than one communication network. Server 502 is shown communicatively coupled to computing device 518 through communication network 514. While not shown in FIG. 5, server 502 may be directly communicatively coupled to computing device 518, for example, in a system absent or bypassing communication network 514.

Communication network 514 may comprise one or more network systems, such as, without limitation, an internet, LAN, WIFI or other network systems suitable for audio processing applications. In some embodiments, system 500 excludes server 502, and functionality that would otherwise be implemented by server 502 is instead implemented by other components of system 500, such as one or more components of communication network 514. In still other embodiments, server 502 works in conjunction with one or more components of communication network 514 to implement certain functionality described herein in a distributed or cooperative manner. Similarly, in some embodiments, system 500 excludes computing device 518, and functionality that would otherwise be implemented by computing device 518 is instead implemented by other components of system 500, such as one or more components of communication network 514 or server 502 or a combination. In still other embodiments, computing device 518 works in conjunction with one or more components of communication network 514 or server 502 to implement certain functionality described herein in a distributed or cooperative manner.

Computing device 518 includes control circuitry 528, display 534 and input circuitry 516. Control circuitry 528 in turn includes transceiver circuitry 562, storage 538 and processing circuitry 540. In some embodiments, computing device 518 or control circuitry 528 may be configured as media device 600 of FIG. 6.

Server 502 includes control circuitry 520 and storage 524. Each of storages 524 and 538 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 524, 538 may be used to store various types of content, metadata, and or other types of data (e.g., they can be used to store congruent objects identified in a secondary content item or a list of those congruent objects, identifiers to media assets having the shared congruent objects, ranking and scoring relating to the media assets, recommendations provided by the ad server, display instructions on how to display the selected media asset on a social media platform, and algorithms, such as the AI algorithm). Non-volatile memory may also be used (e.g., to launch a boot-up routine and other instructions). Cloud-based storage may be used to supplement storages 524, 538 or instead of storages 524, 538. In some embodiments, data relating to congruent objects identified in a secondary content item or a list of those congruent objects, identifiers to media assets having the shared congruent objects, ranking and scoring relating to the media assets, recommendations provided by the ad server, display instructions on how to display the selected media asset on a social media platform, and data relating to all other processes and features described herein, may be recorded and stored in one or more of storages 512, 538.

In some embodiments, control circuitry 520 and/or 528 executes instructions for an application stored in memory (e.g., storage 524 and/or storage 538). Specifically, control circuitry 520 and/or 528 may be instructed by the application to perform the functions discussed herein. In some implementations, any action performed by control circuitry 520 and/or 528 may be based on instructions received from the application. For example, the application may be implemented as software or a set of executable instructions that may be stored in storage 524 and/or 538 and executed by control circuitry 520 and/or 528. In some embodiments, the application may be a client/server application where only a client application resides on computing device 518, and a server application resides on server 502.

The application may be implemented using any suitable architecture. For example, it may be a stand-alone application wholly implemented on computing device 518. In such an approach, instructions for the application are stored locally (e.g., in storage 538), and data for use by the application is downloaded on a periodic basis (e.g., from an out-of-band feed, from an internet resource, or using another suitable approach). Control circuitry 528 may retrieve instructions for the application from storage 538 and process the instructions to perform the functionality described herein. Based on the processed instructions, control circuitry 528 may determine a type of action to perform in response to input received from input circuitry 516 or from communication network 514. For example, in response to identifying congruent objects in a secondary content item, or that a secondary content item is consumed, such as described in blocks 101-103 of FIG. 1 and blocks 201-203 of FIG. 1, the control circuitry 528 may perform the steps of processes described in FIGS. 1-4, 7A-8, and 14 below and all the steps and processes described in all the figures depicted herein.

In client/server-based embodiments, control circuitry 528 may include communication circuitry suitable for communicating with an application server (e.g., server 502) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 514). In another example of a client/server-based application, control circuitry 528 runs a web browser that interprets web pages provided by a remote server (e.g., server 502). For example, the remote server may store the instructions for the application in a storage device. The remote server may process the stored instructions using circuitry (e.g., control circuitry 528) and/or generate displays. Computing device 518 may receive the displays generated by the remote server and may display the content of the displays locally via display 534. This way, the processing of the instructions is performed remotely (e.g., by server 502) while the resulting displays, such as the display windows described elsewhere herein, are provided locally on computing device 518. Computing device 518 may receive inputs from the user via input circuitry 516 and transmit those inputs to the remote server for processing and generating the corresponding displays. Alternatively, computing device 518 may receive inputs from the user via input circuitry 516 and process and display the received inputs locally, by control circuitry 528 and display 534, respectively.

Server 502 and computing device 518 may transmit and receive content and data such as objects, frames, snippets of interest, and input from primary devices and secondary devices, such as AR devices. Control circuitry 520, 528 may send and receive commands, requests, and other suitable data through communication network 514 using transceiver circuitry 560, 562, respectively. Control circuitry 520, 528 may communicate directly with each other using transceiver circuits 560, 562, respectively, avoiding communication network 514.

It is understood that computing device 518 is not limited to the embodiments and methods shown and described herein. In nonlimiting examples, computing device 518 may be a primary device, a personal computer (PC), a laptop computer, a tablet computer, a WebTV box, a personal computer television (PC/TV), a PC media server, a PC media center, a handheld computer, a mobile telephone, a smartphone, a virtual, augment, or mixed reality device, or a device that can perform function in the metaverse, or any other device, computing equipment, or wireless device, and/or combination of the same capable of suitably displaying primary content and secondary content.

Control circuitry 520 and/or 518 may be based on any suitable processing circuitry such as processing circuitry 526 and/or 540, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 520 and/or control circuitry 518 are configured to receive an indication of content consumed by a user, receive an indication of a shopping website browsed by a user, access previous purchases made by a user, access smart home/IoT devices and electronic devices associated with the user to monitor voice and data inputs relating to the user's consumption and interest in a product or service, compare congruent objects in media assets posted on a social media platform to recommendations provided by an advertisement server, score the posted media assets based on their relevance to the recommendations, determine their display on the social media platform, such as in a social media feed or a “For You” page, based on the recommendation, which may range from soft to hard, or low to high priming and warming up, identify relevant media assets posted on a social platform and using them to warmup, prime, or engage a user prior to their consumption of an identified secondary content item, such as an advertisement, and perform all processes described and shown in connection with FIGS. 1-4, 7A-8, and 14.

Computing device 518 receives a user input 504 at input circuitry 516. For example, computing device 518 may receive a user input like a media asset has been consumed by a user or that the user has browsed a shopping website.

Transmission of user input 504 to computing device 518 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, or any other suitable wireless transmission protocol. Input circuitry 516 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, or other wireless transmission protocols.

Processing circuitry 540 may receive input 504 from input circuit 516. Processing circuitry 540 may convert or translate the received user input 504 that may be in the form of voice input into a microphone, or movement or gestures to digital signals. In some embodiments, input circuit 516 performs the translation to digital signals. In some embodiments, processing circuitry 540 (or processing circuitry 526, as the case may be) carries out disclosed processes and methods. For example, processing circuitry 540 or processing circuitry 526 may perform processes as described in FIGS. 1-4, 7A-8, and 14, respectively.

FIG. 6 shows a generalized embodiment of an electronic equipment device 600, in accordance with one embodiment. In an embodiment, the equipment device 600, is the same equipment device 502 of FIG. 5. The equipment device 600 may receive content and data via input/output (I/O) path 602. The I/O path 602 may provide audio content (e.g., broadcast programming, on-demand programming, internet content, content available over a local area network (LAN) or wide area network (WAN), and/or other content) and data to control circuitry 604, which includes processing circuitry 606 and a storage 608. The control circuitry 604 may be used to send and receive commands, requests, and other suitable data using the I/O path 602. The I/O path 602 may connect the control circuitry 604 (and specifically the processing circuitry 606) to one or more communications paths. I/O functions may be provided by one or more of these communications paths but are shown as a single path in FIG. 6 to avoid overcomplicating the drawing.

The control circuitry 604 may be based on any suitable processing circuitry such as the processing circuitry 606. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client-server-based embodiments, the control circuitry 604 may include communications circuitry suitable for allowing communications between two separate user devices to receive an indication of content consumed by a user, receive an indication of a shopping website browsed by a user, access previous purchases made by a user, access smart home/IoT devices and electronic devices associated with the user to monitor voice and data inputs relating to the user's consumption and interest in a product or service, compare congruent objects in media assets posted on a social media platform to recommendations provided by an advertisement server, score the posted media assets based on their relevance to the recommendations, determine their display on the social media platform, such as in a social media feed or a “For You” page, based on the recommendation, which may range from soft to hard, or low to high priming and warming up, identify relevant media assets posted on a social platform and using them to warmup, prime, or engage a user prior to their consumption of an identified secondary content item, such as an advertisement, and perform all related functions and processes as described herein. The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 608 that is part of the control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 608 may be used to store congruent objects identified in a secondary content item or a list of those congruent objects, identifiers to media assets having the shared congruent objects, ranking and scoring relating to the media assets, recommendations provided by the ad server, display instructions on how to display the selected media asset on a social media platform and all the functionalities and processes discussed herein. Cloud-based storage, described in relation to FIG. 6, may be used to supplement the storage 608 or instead of the storage 608.

The control circuitry 604 may include audio generating circuitry and tuning circuitry, such as one or more analog tuners, audio generation circuitry, filters or any other suitable tuning or audio circuits or combinations of such circuits. The control circuitry 604 may also include scaler circuitry for upconverting and down converting content into the preferred output format of the electronic device 600. The control circuitry 604 may also include digital-to-analog converter circuitry and analog-to-digital converter circuitry for converting between digital and analog signals. The tuning and encoding circuitry may be used by the electronic device 600 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 608 is provided as a separate device from the electronic device 600, the tuning and encoding circuitry (including multiple tuners) may be associated with the storage 608.

The user may utter instructions to the control circuitry 604, which are received by the microphone 616. The microphone 616 may be any microphone (or microphones) capable of detecting human speech. The microphone 616 is connected to the processing circuitry 606 to transmit detected voice commands and other speech thereto for processing. In some embodiments, voice assistants (e.g., Siri, Alexa, Google Home and similar such voice assistants) receive and process the voice commands and other speech.

The electronic device 600 may include an interface 610. The interface 610 may be any suitable user interface, such as a remote control, mouse, trackball, keypad, keyboard, touch screen, touchpad, stylus input, joystick, or other user input interfaces. A display 612 may be provided as a stand-alone device or integrated with other elements of the electronic device 600. For example, the display 612 may be a touchscreen or touch-sensitive display. In such circumstances, the interface 610 may be integrated with or combined with the microphone 616. When the interface 610 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 610 may be HDTV-capable. In some embodiments, the display 612 may be a 3D display. The speaker (or speakers) 614 may be provided as integrated with other elements of electronic device 600 or may be a stand-alone unit. In some embodiments, the display 612 may be outputted through speaker 614.

The equipment device 600 of FIG. 6 can be implemented in system 500 of FIG. 5 as primary equipment device 502, but any other type of user equipment suitable for allowing communications between two separate user devices for performing the functions elated to implementing machine learning (ML) and artificial intelligence (AI) algorithms, and all the functionalities discussed associated with the figures mentioned in this application

The electronic device 600 of any other type of suitable user equipment suitable may also be used to implement ML and AI algorithms, and related functions and processes as described herein. For example, primary equipment devices such as television equipment, computer equipment, wireless user communication devices, or similar such devices may be used. Electronic devices may be part of a network of devices. Various network configurations of devices may be implemented and are discussed in more detail below.

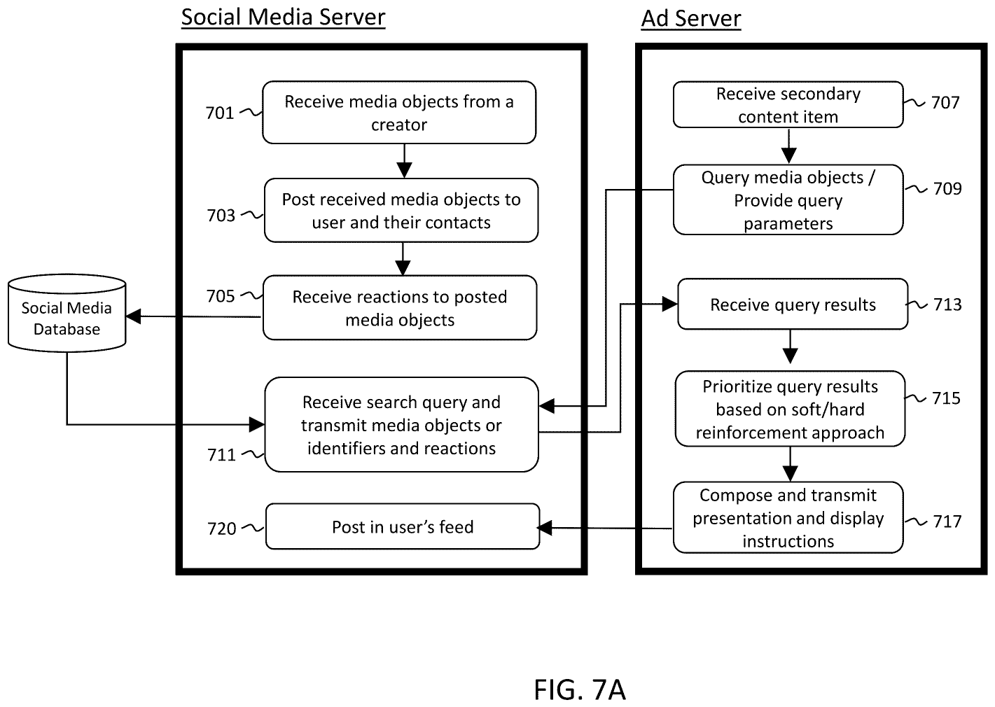

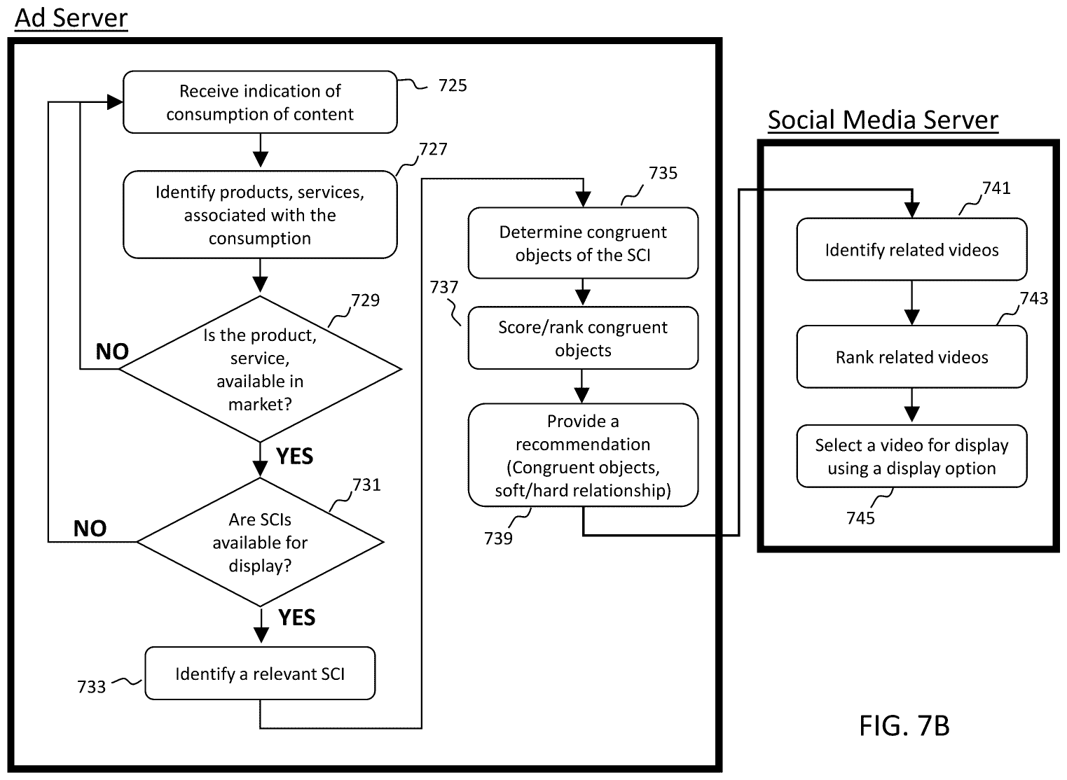

FIGS. 7A and 7B are flowcharts of examples of processes for displaying a media object in a feed based on shared congruent objects of the media object with a secondary content item, in accordance with some embodiments of the disclosure.

In one embodiment, as depicted in FIG. 7A, a social media server and a secondary content item server are used. At block 701, the social media server receives media assets from a creator. The creator maybe a contact of the user on the social media platform hosted by the social media server or a professional third-party creator that is not connected to the user.

At block 703, the social media server may post the received media assets to the user and their contacts on the social media platform. The social media server may post these media assets in social media feeds of the user and their contacts.

At block 705, the social media server may receive reactions to the posted media assets. These reactions may include “likes,” “dislikes,” “thumbs up,” “thumbs down,” and comments associated with the posted media assets. It may also receive a series of back-and-forth comments from multiple users, creating a common thread for the posted media object. The social media server may store the media assets and all the reactions received in a social media database.

At block 707, the ad server may receive a secondary content item. The secondary content item may be received from a plurality of sources. For example, the secondary content item may be received from an ad agency or may be generated by the ad server.

At block 709, in response to receiving the secondary content item, the ad server may query the social media server for media assets that include congruent objects that are shared with the received secondary content item. The ad server may recommend parameters that are associated with congruent objects from the secondary content item to the social media server to perform the search. In one embodiment, the congruent objects recommended are the product or service being sold in the secondary content item or closely related to them. If such directly related congruent objects are recommended, the ad server may be deploying a hard reinforcement strategy where the warming up media assets displayed to a user are directly related to the product or service being sold. In another embodiment, the congruent objects recommended are not the product or service being sold in the secondary content item but other objects that do refer to the product or service being sold but are used as a backdrop or in a supporting role. For example, if the secondary content item is for a toothpaste and the media asset displays people smiling and laughing, recommending objects other than the toothpaste or closely related to it, such as the people smiling, the ad server may be deploying a soft reinforcement strategy.

At block 711, in response to receiving a search query with the recommended congruent objects, the social media server may access the social media database in which media assets and their reactions are stored. The social media server may query the social media database to obtain those media assets and reactions that include congruent objects that are recommended in the search query. The social media server may then transmit the media assets, or an identifier associated with the media asset, and their reactions, or identifiers to the media assets and their reactions, to the ad server.

At block 713, the ad server may receive the search query results, which include media assets and their reactions. At block 715, the ad server may prioritize the query results based on a soft or hard reinforcement approach used. The ad server may then compose a presentation, which includes the prioritized media object and the secondary content item, and then transmit the presentation along with display instructions to the social media server. In some embodiments, the display instructions may be to perform auto play of the presentation and display the presentation at the top of the user's social media feed. Other display instructions described in reference to FIG. 10 may also be used.

At block 720, the social media server may receive the transmitted presentation and post the presentation in the user's feed in accordance with the display instructions provided.

In one embodiment, as depicted in FIG. 7B, a social media server and an ad server are used. At block 725, the ad server receives an indication of consumption of content. The consumption of content may be any of browsing a website, surfing on an online shopping platform, purchasing a product, discussing a product or service with a person using an electronic device such as through a voice call or text messaging, or consuming using any other input categories listed in FIG. 9.

At block 727, the ad server identifies products or services associated with the consumption. This includes determining whether the consumption of content includes any objects that can be associated with a product or service. At block 729, the ad server determines if the product or service is available in the marketplace. If the product or service is not available in the marketplace, the ad server continues to monitor the user's consumption and receive indications of consumption of content.

If a determination is made at block 729 that the product or service is associated with a product or service available in the market, then the ad server at block 731 determines if there are any secondary content items (SCIs) available for display for the product or service identified in block 729. If one of more secondary content items are available, the ad server may select one of the secondary content items at block 733.

In some embodiments, the ad server may receive a secondary content item from an ad agency prior to performing the steps outlined in blocks 727-729. In such embodiments, the ad server may already have the data associated with the secondary content item and would not have to perform the steps in blocks 729-733 to determine the availability of the product or availability of a secondary content item.

At block 735, regardless of whether the secondary content item (SCI) was previously received from an ad agency, or the ad server had to make a determination if a secondary content item associated with the consumption of content was available, the ad server may determine congruent objects associated with the secondary content item.

At block 737, the ad server may score and rank the congruent objects and provide a recommendation to the social media server based on the scored and ranked congruent objects.

The scoring and ranking of the congruent objects may be performed based on the type of reinforcement strategy selected. In some embodiments, the soft reinforcement approach may be associated with those congruent objects that are not the core focus of the secondary content item, i.e., not the product or service being sold in the secondary content item. In other embodiments, a hard or direct reinforcement approach may be associated with those congruent objects that are the core focus of the secondary content item or closer to the core focus of the secondary content item with a variation that is within a variation threshold.

At block 741, the social media server may receive the recommendations provided by the ad server, which are based on the reinforcement strategy selected. Based on the recommendation, the social media server may query media assets posted on its platform to determine which media assets include the recommended congruent objects. In some embodiments, the media assets queried may be only those media assets that are posted by contacts of the user or only those media assets posted on the social media feeds of the user or their contacts.

At block 743, the social media server may rank the related media assets and use their ranking to determine an order of display for the related media assets in the user's social media feed. At block 745, the social media server may display the ranked media assets based on a display option, such as a display option selected in the description of FIG. 10.

FIG. 8 is flowchart of a process for determining the display order for media assets in a social media feed, in accordance with some embodiments of the disclosure.

At block 805, the social media server receives a recommendation from an ad server. As mentioned earlier, the recommendation is based on a reinforcement strategy selected by the ad server. These include a soft reinforcement strategy, a hard reinforcement strategy, or a reinforcement strategy somewhere in between.

At block 810, the social media server accesses media assets posted on the online platform. In some embodiments, the media assets accessed may be only those media assets that are posted by contacts of the user or only those media assets posted on the social media feeds of the user or their contacts.

At block 815, the social media server evaluates the accessed media assets to determine whether a first media asset includes at least one congruent object that is shared with the recommended congruent object. If a determination is made that the first media asset does not include any congruent objects that are shared with the recommended congruent objects, then the social media server returns to block 810 and continues to access media assets and evaluate them.

If a determination is made at block 815 that the first media asset includes at least one congruent object that is shared with the recommended congruent object, then the process moves to block 820.

At block 820, in some embodiments, the social media server accesses a second media asset and determines if the second media asset includes more congruent objects than the first media asset that are shared with the recommended congruent object. In other embodiments, the social media server accesses a second media asset and determines if the second media asset includes congruent objects that are more relevant to the recommended congruent object than the first media asset.

At block 820, if a determination is made that the second media asset includes either more congruent objects than the first media asset or includes congruent objects of a higher relevance than the first media asset, then the social media server ranks the second media asset higher than the first media asset. Based on the ranking, the social media server displays the second media asset higher in a social media feed than the first media asset, as depicted in block 825.

At block 820, if a determination is made that the second media asset does not include either more congruent objects than the first media asset or does not include congruent objects of a higher relevance than the first media asset, then the social media server ranks the first media asset higher than the second media asset. Based on the ranking, the social media server displays the first media asset higher in a social media feed than the second media asset, as depicted in block 830.

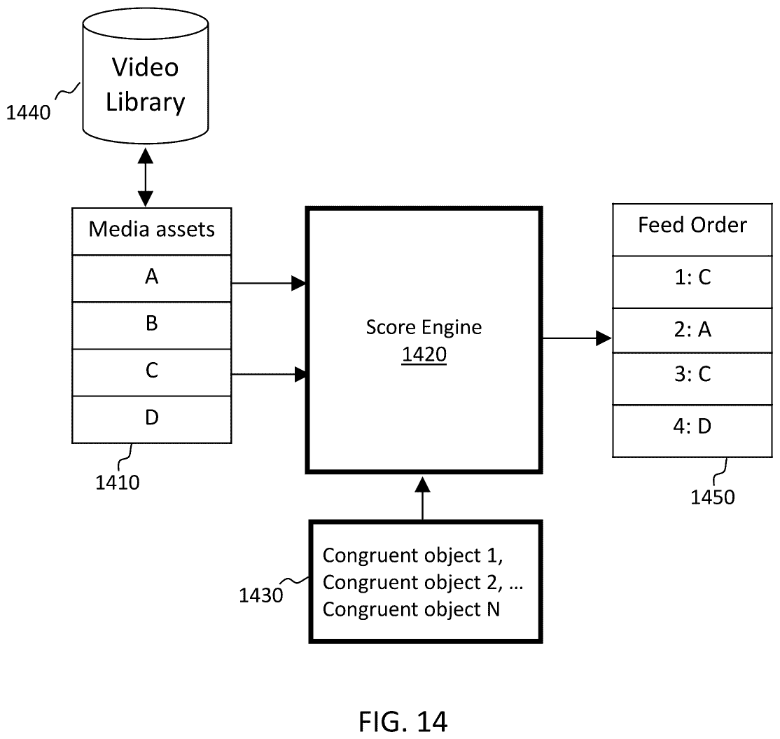

In some embodiments, the first media asset and second media asset may be scored by a scoring engine, such as the scoring engine described in the description of FIG. 14. The scores may be assigned to each media asset based on either a) the number of congruent objects in each media asset that match (e.g., are in the same genre as) the secondary content item, orb) the relevance of the congruent objects in each media asset to the congruent objects in the secondary content item.

FIG. 9 is a block diagram of input categories used in identifying a related secondary content item, in accordance with some embodiments of the disclosure.

As mentioned earlier, the ad server may receive an indication of consumption of content by the user. As depicted in block 905, one of the input categories from which an indication of consumption may be received by the ad server is consumption of media assets. This includes media assets such as movies, TV shows, documentaries, videos, short clips, and other such media consumed using an electronic device, such as a media device, mobile phone or another computing device.

As depicted in block 910, another one of the input categories from which an indication of consumption may be received by the ad server is online shopping carts. In this embodiment, a user may have browsed through products or services offered by an online shopping platform. The user may have hovered over a product, selected a product, placed the product in a shopping cart, abandoned a product after selecting it, gazed at the product, or perform any other action that is indicative of the user's interest in the product.

As depicted in block 915, another one of the input categories from which an indication of consumption may be received by the ad server is previous purchases. In this embodiment, the ad server may receive data relating to a user's previous purchases. The data relating to previous purchases may be received from online shopping platforms, credit cards and banks, the user's recording of purchases in a database, or user statements or texts.

With respect to online purchases made by the user, either the user or the shopping platform may authorize the ad server to access data relating to the user's online purchases. In some instances, the shopping platform may be associated with generating its own secondary content items or getting secondary content items from an ad agency and using its own ad servers to analyze user's previous purchases. Using the data, the ad server may identify secondary content items, determine congruent objects in the secondary content items, and perform the processes described in FIGS. 1-2, 4, 7A-7B and 8.

With respect to purchases made by the user that are not online, the user's credit card and bank activity may be accessed and analyzed to determine which products were bought. Using the data, the ad server may identify secondary content items, determine congruent objects in the secondary content items, and perform the processes described in FIGS. 1-2, 4, 7A-7B and 8.

In some instances, the user may make statements, either vocal or textual, when speaking or texting to someone using their mobile device that indicate that they have purchased a certain product. The user may also email someone with such information. Such data may be accessed and used by the ad server to identify secondary content items, determine congruent objects in the secondary content items, and perform the processes described in FIGS. 1-2, 4, 7A-7B and 8.

An audio input, as depicted in block 920, may also be used as an input category. For example, if a user is speaking to someone using their mobile phone and expresses an interest in a particular product, such audio input may be captured by the user's mobile phone. The product data or interest discussed on the mobile phone may be used as input by the ad server to identify secondary content items, determine congruent objects in the secondary content item, and perform the processes described in FIGS. 1-2, 4, 7A-7B and 8.

Data captured by smart home and IoT devices, as depicted in block 925, may also be used as an input category. For example, a camera of a smart home device may capture user gestures when the user is gazing at a product or consuming a media asset on their TV. An IoT device at a mall, parking lot, storefront, or home may capture user gestures or gaze when they are gazing at a displayed product. Likewise, statements made by the user to a digital assistant or responses received from a digital assistant may also be used as an input category. Such smart home and IoT device data may be used by the ad server to identify secondary content items, determine congruent objects in the secondary content item, and perform the processes described in FIGS. 1-2, 4, 7A-7B and 8.

An input by use of an electronic device, as depicted in block 930, such as phone calls, texts, SMS, or WhatsApp™ activity may also be used as input by the ad server to identify secondary content items, determine congruent objects in the secondary content item, and perform the processes described in FIGS. 1-2, 4, 7A-7B and 8.

An input based on internet surfing on websites, including any online search history, as depicted in block 940, using search engines like Google™ and Yahoo™, as depicted in block 935, may be used as input by the ad server to identify secondary content items, determine congruent objects in the secondary content item, and perform the processes described in FIGS. 1-2, 4, 7A-7B and 8.

FIG. 10 is a block diagram of display options for displaying an identified media asset in a social media feed, in accordance with some embodiments of the disclosure.

In some embodiments, the display options may be used to display a presentation, or a media asset selected by the social media or ad server in the user's social media feed. As depicted in block 1005, in one embodiment, a display option recommended either by the ad server or determined by the social media server may be to auto play the presentation or the selected media asset in the media feed of the user. In this embodiment, the control circuitry may display the presentation or selected media asset such that it is visible to the user and without user intervention, that is, automatically play it such that the user is able to consume the displayed media asset.

In another embodiment, the user may be scrolling through their feed. In this embodiment, the display option, as depicted in block 1010, may be to scroll the presentation or selected media asset dynamically while the user is scrolling the feed such that the presentation or selected media asset is always displayed to the user during the scrolling action.

Another display option, as depicted in block 1015, may be to enhance the displayed presentation or selected media asset. The enhancements may include highlighting the selected media asset, using a boundary, coloring certain areas of the media asset, displaying the media asset in a larger space than other media assets, or other enhancement that make the media asset stand out among other media assets displayed in the vicinity in the user's social media feed.

Yet another display option, as depicted in block 1020, is to display thumbnails of the presentation or selected media asset. The thumbnails may be displayed in the social media feed or any location on the user interface of the social media platform that would be visible to the user.

As depicted in block 1025, another display option may be to display the presentation or selected media asset near the vicinity of the secondary content item on the on the social media platform.

In another embodiment, the display option, as depicted in block 1030, may be to display the presentation or selected media asset as a pop-up within the user interface of the social media platform. The pop-up may be selected by the user to play the media asset, or the pop-up may auto play the media asset without any user input.

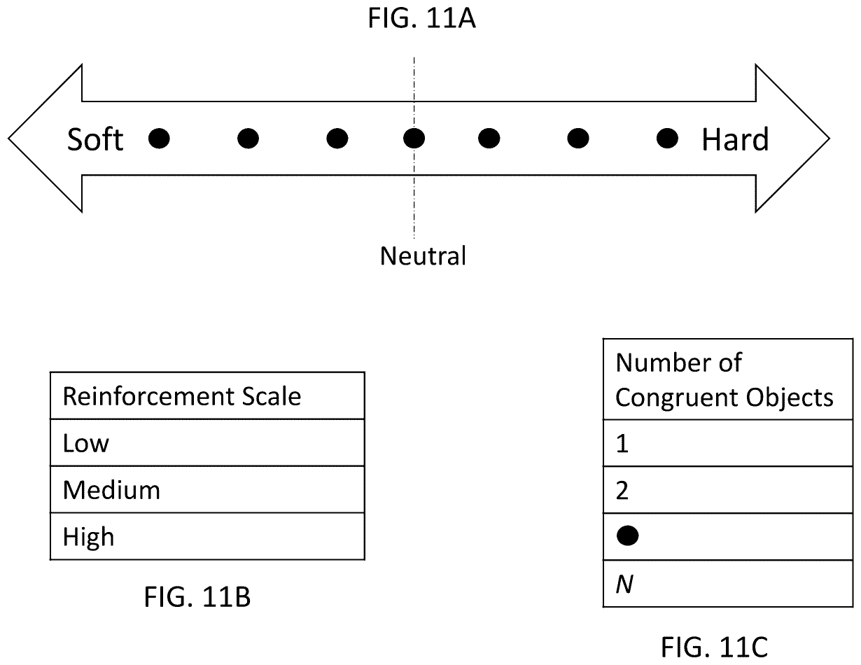

FIG. 11A-C are block diagrams and tables of examples of a sliding scale that ranges from soft to hard reinforcements used in identifying media assets on a social media platform, in accordance with some embodiments of the disclosure.

As described earlier, a determination is made whether to use a soft or a hard/direct reinforcement strategy for selecting a warming or priming media asset that is to be displayed to the user prior to their consumption of the secondary content item. The hard reinforcement strategy, as mentioned earlier, is associated with using warming media assets or presentations that include those congruent objects that are shared with the core focus of the secondary content item, but not the product being sold in the secondary content item. The soft reinforcement approach, as described earlier, is associated with those congruent objects that are not the core focus of the secondary content item, i.e., not the product of focus in the secondary content item.

The slider shown in FIG. 11A may be a tool used by the ad server or the social media server to determine the level of reinforcement to use in selecting the warming or priming media asset or presentation. As depicted in FIG. 11A, a reinforcement scale may be represented in the form of a slider. The ad server or social media server may select any position on the slider to select any level in between soft and hard reinforcement.

FIGS. 11B and 11C are other examples of reinforcement scales that may be used by the ad server or social media server. A relevancy scale, as depicted in FIG. 11B, may include a low, medium, or high level. The low level may be associated with one end of the spectrum and associated with a soft reinforcement strategy, the high level may be associated with another end of the spectrum and associated with a hard/direct reinforcement strategy, while a medium level may represent somewhere in between. The scale may also be a numeric scale that goes from 1-N, as depicted in FIG. 11C. Although some examples of reinforcement scales are depicted in FIGS. 11A-C, the embodiments are not so limited, and other levels and types of scales may also be used.

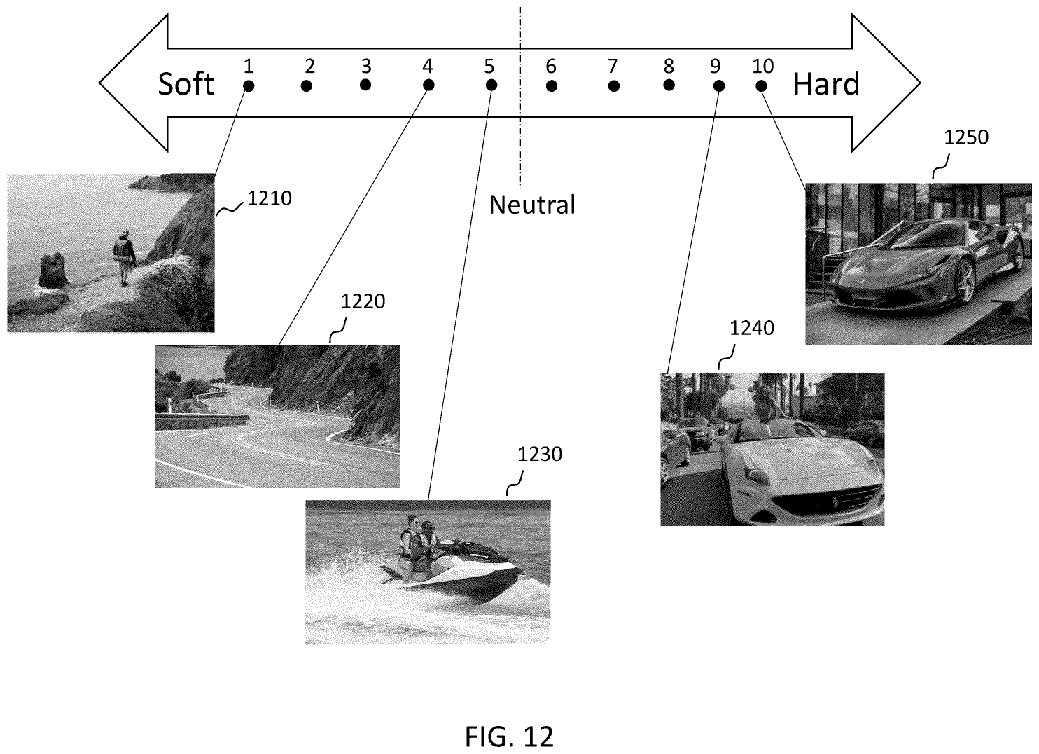

FIG. 12 is an example of a reinforcement scale and media assets associated with the reinforcement scale, in accordance with some embodiments of the disclosure. As depicted in FIG. 12, an adjustable reinforcement scale is depicted having 10 levels of reinforcement. The adjustable reinforcement scale is exemplary, and other values and tiers of reinforcement on other types of scales are also contemplated in the embodiments. The left side of the reinforcement scale is associated with a soft reinforcement level while the right side is associated with a hard reinforcement level. The level of reinforcement from soft to hard can be adjusted from left to right side of the sliding bar with each move towards the right raising the level towards a harder reinforcement.

Some examples of the media assets that can be associated with each level are displayed. For example, in some embodiments, media asset 1210 may be associated with level 1 of the reinforcement scale, which may be the softest reinforcement among all the media assets identified by the social media server. Media asset 1210 depicts a friend of the user hiking along an ocean trail. Since “ocean” is one of the congruent objects that may be recommended by the ad server, the social media server had identified the media asset as related to the congruent object. The congruent objects in the media asset 1210, which are ocean, mountains, hiking trail, and a man hiking through the ocean trail, do not immediately cause someone to associate them with a secondary content item for a red Ferrari. This is because the media asset does not contain any association with a red Ferrari, e.g., a red Ferrari cannot be driven on such a trail, and one would not expect to see a red Ferrari on a cliff edge ocean trail that is narrow enough for just a person to hike on. As such, use of media asset 1210 may be considered to be the softest reinforcement approach based on all the media assets identified. If other media assets included congruent objects that were more far removed from any association with a red Ferrari, then such media assets may have been ranked lower on the scale and to the left side of the media asset 1210.

In some embodiments, media asset 1220 may be associated with a level 4 on the reinforcement scale. Since the media asset includes a curved road as a congruent object, which may have some association with a car, since a car is driven on such a road, it may be ranked higher on the reinforcement scale than media asset 1210. Although a curved road may have some association with driving a car, it does not necessarily jump to being directly associated with a red Ferrari. As such, it may still be ranked on the left side of the reinforcement scale.

In some embodiments, media asset 1230 may be associated with a level 5 on the reinforcement scale. Media asset 1230 includes congruent elements that may represent both a feeling and a physical object, i.e., the ocean. The feeling and emotion may be that of the “speed,” “thrill,” “excitement,” and “adrenaline” that are experienced in a fast-driving jet ski, which are closely related to emotions and feelings experienced while driving Ferrari at a high speed on a curved highway. As such, media asset 1230 may be farther to the right towards the hard reinforcement level than media assets 1210 and 1220. In other embodiments, media asset 1230 may be ranked lower and closer to the soft reinforcement side if it is evaluated without considering the emotions and feelings associated with the media asset and using only displayed congruent objects for evaluation of a reinforcement level.

In some embodiments, media asset 1240 may be associated with a level 9 on the reinforcement scale. Although it is not the exact red Ferrari in the secondary content item, it is still a Ferrari, just in a different color. As such, the media asset would be high on the reinforcement scale, as it is directly related to a red Ferrari.

In some embodiments, media asset 1250 may be associated with a level 10 on the reinforcement scale since it may be the exact product that is being sold in the secondary content item.

In some embodiments, the warming up media assets 1210-1250 may be scored by a scoring engine, such as the scoring engine described in the description of FIG. 14. The scores may be assigned to each media asset based on either a) the number of congruent objects in each media asset that match (i.e., are in the same genre) as the secondary content item, orb) the relevance of the congruent objects in each media asset to the congruent objects in the secondary content item. The scores may also be associated with a soft or a hard reinforcement strategy. For example, media asset 1210 may be scored the highest when a soft reinforcement strategy is used and the lowest when a hard reinforcement strategy is used. Likewise, media asset 1250 may be scored the lowest when a soft reinforcement strategy is used and the highest when a hard reinforcement strategy is used.

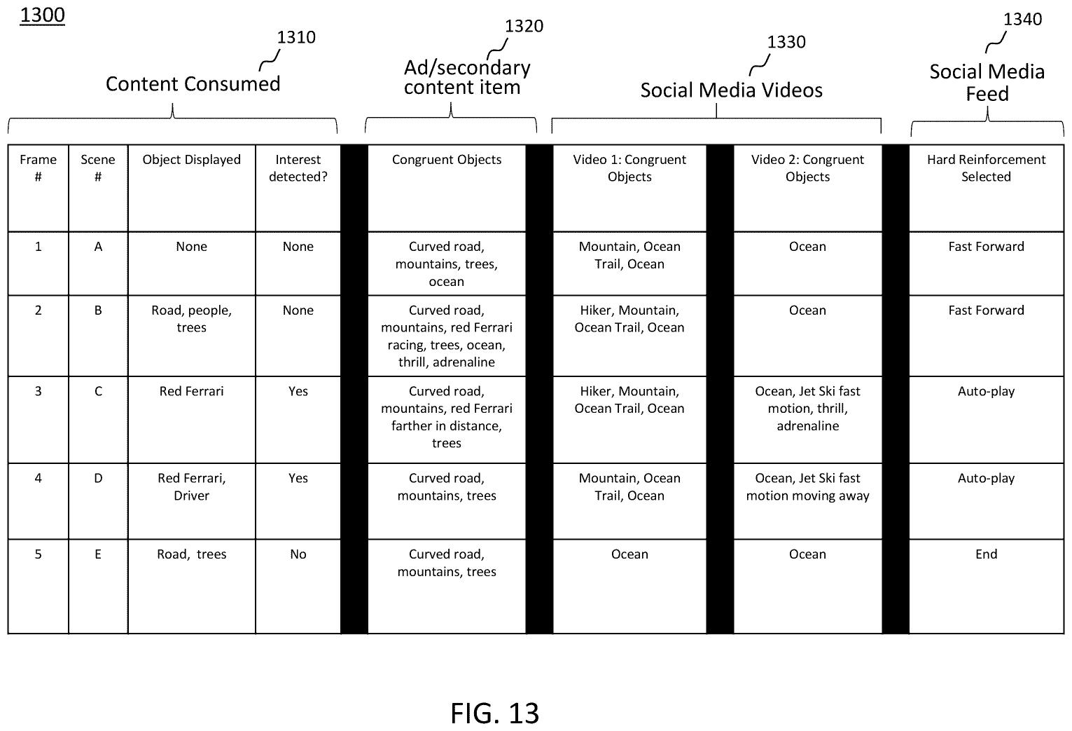

FIG. 13 is a data structure for identifying media assets posted on a social media platform and determining their order of display in a social media feed based on the media assets' shared congruent objects with a secondary content item, in accordance with some embodiments of the disclosure.

As depicted in FIG. 13, data structures may be generated for content consumed 1310, secondary content item 1320, social media assets 1330, and social media feed 1340.

In some embodiments, data structure for content consumed 1310 may be used to determine the interest of the user in a product or service displayed in the content. As depicted, the user displayed some interest when a red Ferrari was shown in frames 3 and 4 of content consumed. As mentioned earlier, in some embodiments, the initial determination of user interest is made to understand what products, services, content, and contexts excite the user and are interesting to them. Without understanding such initial interest, the system would be delivering a secondary content item without considering its relevance to the user interest.

Based on the user's interest, a related secondary content item that includes a Ferrari may have been identified as depicted in data structure 1320. The frames of the secondary content item may include different congruent objects such as a curved road, mountains, trees and a red Ferrari. Congruent objects from the secondary content item may be selected and a recommendation based on the selected congruent objects may be provided to the social media server for identifying media assets posted on the social media platform that include one or more of the recommended congruent objects. As depicted in social media videos data structure 1330, multiple media assets may be identified that include one or more of the recommended congruent objects. As mentioned earlier, in addition to displayed congruent objects, the secondary content item may also be analyzed by an AI engine running an AI algorithm to determine the emotions and feelings involved in a frame or scene of the secondary content item. Such feelings or emotions (e.g., adrenaline and thrill) may also be used as a recommendation to the social media server for identifying media assets that include such feelings and emotions. The media assets 1 and 2 may also be scored by a scoring engine, such as the scoring engine described in the description of FIG. 14 based on either a) the number of congruent objects in each media asset that match (e.g., are in the same genre) as the secondary content item, or b) the relevance of the congruent objects in each media asset to the congruent objects in the secondary content item.

Based on the recommendation provided by the ad server, which in this example uses a hard reinforcement strategy, a social media feed data structure 1340 for the selected media assets that includes the congruent objects and emotions and feelings that align with the hard reinforcement strategy is selected. The media assets may be fast-forwarded to a frame or frames that align with the recommendations, such as frames 3 and 4, and the identified media asset or media assets may be auto played in the user's social media feed. Although references to a social media feed are described, the embodiments are not so limited and display in a “For You” page of the social media platform or display at other locations in the platform are also contemplated.

FIG. 14 depicts a scoring engine and process applied for scoring media assets posted on a social media platform for determining their display order, in accordance with some embodiments of the disclosure.

In some embodiments, the scoring engine 1420 may be used by the ad server. In other embodiments, the scoring engine 1420 may be used by the social media server. Regardless of whether the ad server or the social media server uses the scoring engine, it may be used to score media assets that include congruent objects, or presentations generated by the ad server, to determine the priority of the media assets or presentations in a user's social media feed.

In some embodiments, a recommendation is provided to the social media server to identify media assets. The recommendation may be based on congruent objects. Based on the recommendation, the social media server may access a media asset library that stores media assets posted on the social media platform. A plurality of media assets from the media asset library 1440, such as media assets A-D 1410, may be identified that match the recommendations.

The scoring engine may analyze each of the identified media assets A-D 1410 and calculate a score based on the match between the congruent objects in the media assets A-D with the congruent objects recommended 1430. Scores may be assigned to each media asset based on relevance of the match or the number of matches. Once scores are assigned, the order of the media asset in the social media feed may be determined based on the assigned score. In one example, as depicted in the feed order 1450, media asset C was assigned the highest score while media asset D was assigned the lowest score. Accordingly, media asset C is displayed at the top of the user's social media feed.

It will be apparent to those of ordinary skill in the art that methods involved in the above-mentioned embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
automatically accessing an electronic device associated with a user to monitor user consumption activity as it relates to consumption of a secondary content item;
receiving, by a social media server, a recommendation for selecting one or more media assets, from a plurality of media assets, posted on a social media platform, wherein the one or more media assets are not same as the consumed secondary content item and the recommendation is based on one or more congruent objects identified in the secondary content item;
in response to receiving the recommendation:
automatically selecting a media asset, by the social media server, from the plurality of media assets, that includes one or more of the congruent objects; and
transmitting display instructions for displaying the selected media asset on the social media platform.

2. The method of claim 1, wherein the one or more congruent objects are objects in the secondary content item but not a product advertised in the secondary content item.

3. The method of claim 1, wherein the one or more congruent objects are objects in the secondary content item that are in a same genre as a product advertised in the secondary content item.

4. The method of claim 1, wherein the one or more congruent objects are products or services that are a subject of the secondary content item.

5. The method of claim 1, wherein the recommendation for selecting one or more media assets is specific to a congruent object from the secondary content item and is based on any one of a) an interaction between a user and an internet website, b) an interaction between the user and an online shopping platform, c) products or services previously purchased by the user, d) an interaction between the user and a digital assistant, and e) products or services associated with the user's interest.

6. (canceled)

7. The method of claim 1, wherein automatically selecting the media asset that includes one or more of the congruent objects further comprises:
comparing the one or more congruent objects in the media asset, from the plurality of media assets, to the recommended specific congruent object;
determining whether the one or more congruent objects in the media asset are in a same genre as the recommended specific congruent object; and
automatically selecting the media asset in response to determining that the one or more congruent objects in the media asset are in the same genre as the recommended specific congruent object.

8. The method of claim 1, wherein the display instructions instruct the selected media asset to be displayed at the top of a social media feed in the social media platform and auto-play the selected media asset.

9. (canceled)

10. The method of claim 1, wherein the display instructions instruct displaying the selected media asset higher in order in a social media feed than other media assets that a) do not include any congruent objects or b) include a lesser number of congruent objects than the selected media asset.

11-26. (canceled)

27. The method of claim 1, wherein automatically selecting a media asset from the plurality of media assets further comprises:
determining that more than one media asset from the plurality of media assets includes the one or more of the congruent objects;
prioritizing the more than one media assets that include the one or more of the congruent objects; and
selecting the media asset for displaying on the social media platform based on the prioritization.

28. The method of claim 27, wherein prioritizing of the more than one media assets that include the one or more of the congruent objects is based on relevancy of the one or more of the congruent objects included in the plurality of media assets.

29. The method of claim 27, wherein prioritizing of the more than one media assets that include the one or more of the congruent objects is based on a number of the one or more congruent objects present in each of the plurality of media assets that include the one or more of the congruent objects.

30. A system comprising:
communications circuitry to communicate with a social media server; and
control circuitry to:
automatically access an electronic device associated with a user to monitor user consumption activity as it relates to consumption of a secondary content item;
receive a recommendation for selecting one or more media assets, from a plurality of media assets, posted on a social media platform, wherein the one or more media assets are not same as the consumed secondary content item and the recommendation is based on one or more congruent objects identified in the secondary content item;
in response to receiving the recommendation:
automatically select a media asset from the plurality of media assets, that includes one or more of the congruent objects; and
transmit display instructions for displaying the selected media asset on the social media platform.

31. The system of claim 30, wherein the one or more congruent objects are objects in the secondary content item but not a product advertised in the secondary content item.

32. The system of claim 30, wherein the one or more congruent objects are objects in the secondary content item that are in a same genre as a product advertised in the secondary content item.

33. The system of claim 30, wherein the one or more congruent objects are products or services that are a subject of the secondary content item.

34. The system of claim 30, wherein the recommendation for selecting one or more media assets is specific to a congruent object from the secondary content item and is based on any one of a) an interaction between a user and an internet website, b) an interaction between the user and an online shopping platform, c) products or services previously purchased by the user, d) an interaction between the user and a digital assistant, and e) products or services associated with the user's interest.

35. The system of claim 30, wherein automatically selecting the media asset that includes one or more of the congruent objects further comprises, the control circuitry configured to:
compare the one or more congruent objects in the media asset, from the plurality of media assets, to the recommended specific congruent object;
determine whether the one or more congruent objects in the media asset are in a same genre as the recommended specific congruent object; and
automatically select the media asset in response to determining that the one or more congruent objects in the media asset are in the same genre as the recommended specific congruent object.

36. The system of claim 30, wherein the display instructions instruct the control circuitry to display the selected media asset at the top of a social media feed in the social media platform and auto-play the selected media asset.

37. The system of claim 30, wherein the display instructions instruct displaying the selected media asset by the control circuitry higher in order in a social media feed than other media assets that a) do not include any congruent objects orb) include a lesser number of congruent objects than the selected media asset.

38. The system of claim 30, wherein automatically selecting a media asset from the plurality of media assets further comprises, the control circuitry configured to:
determine that more than one media asset from the plurality of media assets includes the one or more of the congruent objects;
prioritize the more than one media assets that include the one or more of the congruent objects; and
select the media asset for displaying on the social media platform based on the prioritization.
